(19) United States
(12) Patent Application Publication
(10) Pub. No.: US 2007/0043608 A1
(43) Pub. Date: Feb. 22, 2007

(54) Recorded customer interactions and training system, method and computer program product

(75) Inventors: John C. May, Roswell, GA (US); Christopher Nelson Strant, Duluth, GA (US); Joseph Henry Owen JR., Douglasville, GA (US); Marc Howard Wallenstein, Roswell, GA (US)

Correspondence Address: VENABLE LLP, P.O. BOX 34385, WASHINGTON, DC, 20043-9998, US

(73) Assignee: Recordant, Inc., Alpharetta, GA (US)

(21) Appl. No.: 11/498,161

(22) Filed: Aug. 3, 2006

Related U.S. Application Data
(60) Provisional application No. 60/709,797, filed on Aug. 22, 2005.

(51) Int. Cl. G07G 1/00; G06F 17/30

(52) U.S. Cl. 705/10

(57) ABSTRACT

A system, method and computer program product for recording customer interactions, analyzing recordings and/or providing quality assessment and/or training is set forth. In an exemplary embodiment of the present invention, a system may include a customer interaction recordation application service provider system, which may include, in an exemplary embodiment, an ambulatory capture device adapted to record at least one audio (and/or video) face-to-face interaction between two parties such as, e.g., between an employee and a customer; an aggregation device which may include a cradle adapted to receive said capture device; an application service provider (ASP) server system adapted for user interactive access and analysis of the at least one captured interaction; and a network coupling the aggregation device to the ASP server system adapted to transmit the at least one captured interaction to the ASP server system upon receipt of the capture device in the cradle.

### CROSS-REFERENCE TO RELATED APPLICATION

This application claims the benefit under 35 U.S.C. §119 (e)(1) of U.S. Provisional Patent Application Ser. No. 60/709,797, to John C. MAY et al., entitled “Recorded Customer Interactions and Training System, Method and Computer Program Product,” filed Aug. 22, 2005, Attorney Docket No. 64862-225754 (formerly 42237-190941), of common assignee to the present invention, the contents of which are incorporated herein by reference in their entirety.

### BACKGROUND OF THE INVENTION

1. Field of the Invention

This invention generally relates to employee to customer interaction. More particularly, this invention relates to employee to customer interaction training methods.

2. Related Art

Management in call centers often monitor interactions between customers and call center employees for quality assurance and training purposes. Conventional systems for analyzing call center interactions include, e.g., but not limited to, U.S. Pat. No. 6,724,887, entitled “Method and system for analyzing customer communications with a contact center,” to Eilbacher, et al., issued Apr. 20, 2004, the contents of which is incorporated herein by reference in its entirety. Also, third party verification services use advanced methods to verify customer purchases, see, e.g., but not limited to, U.S. Pat. No. 6,859,524, entitled “System and method for automated third party verification,” to Unger, et al., issued Feb. 22, 2005, the contents of which is incorporated herein by reference in its entirety. Further, attempts have been made to use call center call logging systems to store face-to-face interactions in a stationary telephony based microphone setting using telephony call logging, but have failed to secure more broad acceptance because of the costly capture architecture involved in call center telephony call logging, see, e.g., but not limited to, U.S. Patent Publication US 2005/0015286, the contents of which is incorporated herein by reference in its entirety.

Banks and convenience stores have for many decades captured audio and/or video for security and forensic evidenciary purposes. Such systems have captured interactions for the security and forensic purposes, but are costly and ill-equipped to provide interactive playback of discrete interactions for other applications.

Hospitals have experimented with routing calls to doctors using ambulatory wireless telephony badges, however, such devices have not been used to capture or store interactions, see U.S. Pat. No. 6,901,255, the contents of which is incorporated herein by reference in its entirety.

Conventionally, however, in the case of small volume, ambulatory face-to-face customer interactions, such as, e.g., but not limited to, sales transactions in retail or automobile sales setting, and hotel check-in, it has been heretofore impossible to capture, monitor and analyze employee to customer interactions for purposes such as, e.g., training, compliance, assessment, etc.

### SUMMARY OF THE INVENTION

Various exemplary embodiments of a system, method and computer program product for recording employee/customer and other face-to-face ambulatory interactions on a low cost ambulatory, portable, digital capture device for training, compliance and assessment purposes are set forth.

An exemplary embodiment of the present invention may include a customer interaction collection and analysis system may include: an ambulatory capture device adapted to capture a face-to-face interaction between two parties; and an analysis system, coupled to the capture device, adapted to receive and analyze the interaction.

An exemplary embodiment of the present invention may further include a collection device adapted to receive the interaction.

An exemplary embodiment of the present invention may include where the capture device may include at least one of: a recording device; a digital device; a wired device; a wireless device; a microphone; a fixed microphone; a portable microphone; a headset capture device; a device that is worn by a user; a device including a radio transmitter; a video camera; an audio capture device; a video capture device; a portable device; an embedded device; a computing device; a communications device; a personal digital assistant (PDA); a handheld device; a pocket PC device; a synchronized device; a witnessed interaction subsystem; a telephony recording device; an audio recording device; a video recording device; a telephony device; a lapel microphone device; a wireless telephony device; a wireless LAN device; a wiretap; a device embedded in clothing; a concealed device; a point of sale (POS) device; a digital audio device; a digital video device; and/or an analog device.

An exemplary embodiment of the present invention may include where the analysis system may include at least one of: a customer relationship management (CRM) system; a sales automation system; means for analyzing customer visits; a human resource management system; an employee scheduling system; and/or a workforce management system.

An exemplary embodiment of the present invention may include where the at least one interaction further may include at least one of: data; audio; video; a recording; a file; a stream; a video stream; an audio stream; a media stream; compressed format data; uncompressed format data; digital data; sampled audio; captured video; digitized analog data; data compressed at least compression format including at least one of: a WAV format, an MP3 format, an OGG format, an MPEG format, an AVI format, and/or another compression format; data uncompressed in a format including at least one of: pulse code modulated (PCM), and/or another uncompressed format; streamed data; transferred data; file transfer data including at least one of: file transfer protocol (FTP), hypertext transfer protocol (HTTP), secure HTTP (HTTPS), a DTMF signal, secure copy protocol (SCP), trivial FTP (TFTP), kermit, and/or xmodem; copied data; a screen capture; a screen capture synchronized with the interaction; and/or digital file storage formatted data.

An exemplary embodiment of the present invention may further include means for recognizing gender of a participant in the interaction; means for recognizing words in the interaction; means for recognizing a number of speakers in the interaction; means for recognizing a number of speakers in the interaction; means for recognizing a language of the interaction; means for recognizing an age of a participant in the interaction; means for identifying a child participant of the interaction; means for recognizing a quality of the interaction; means for recognizing an audio quality of the interaction; means for recognizing a video quality of the interaction; means for evaluating the interaction; means for selecting a particular interaction from a plurality of interactions for review by a reviewer; means for scoring the interaction; means for tracking attributes associated with the interaction, wherein the attributes comprise at least one of: identity of participants in the interaction, time of day of the interaction, temporal attributes of the interaction, duration of the interaction; language of the interaction, dialect of the interaction, age of a participant of the interaction, gender of a participant of the interaction, number of speakers of the interaction, words of the interaction, quality of the interaction, fidelity of the interaction, topic of the interaction, subject of the interaction, and/or other attributes of the interaction; means for capturing a screen associated with the interaction; means for performing voice recognition on the interaction; means for optical character recognition of the interaction; means for pattern recognition of the interaction; means for word spotting on the interaction; means for identifying people from the interaction; means for detecting stress from the interaction; means for detecting emotion from the interaction; means for detecting motion of a participant of the interaction; means for synchronizing detected motion with the interaction; means for identifying location of a participant of the interaction may include at least one of identifying a position in three dimensional space of a participant, identifying a spatial position of the parties of the interaction, and/or identifying a height of a participant; means for identifying geographic location of the interaction; and/or means for geolocating the interaction.

An exemplary embodiment of the present invention may further include means for identifying participants in the interaction; means for evaluating the interaction; means for selecting a particular interaction from a plurality of interactions for review by a reviewer; means for scoring the interaction; means for tracking attributes associated with the interaction, wherein the attributes comprise at least one of: identity of participants in the interaction, time of day of the interaction, temporal attributes of the interaction, duration of the interaction; language of the interaction, dialect of a participant of the interaction, age of a participant of the interaction, gender of a participant of the interaction, number of speakers of the interaction, words of the interaction, quality of the interaction, fidelity of the interaction, topic of the interaction, subject of the interaction, and/or other attributes of the interaction; means for filtering the interaction; means for improving quality of the interaction may include at least one of: means for improving audio quality, and/or means for improving video quality; means for increasing intelligibility of the interaction for at least one of: a human listener, and/or an automated speech recognition system; means for removing noise may include at least one of: means for removing background noise, means for removing air conditioner noise, means for removing heating noise, means for removing clothes rustling noise, and/or means for removing rumbling; and/or means for performing digital speech signal processing may include: means for performing voice recognition; and/or means for performing speech recognition may include at least one of: means for recognizing words, means for recognizing phrases, means for converting speech to text, means for recognizing colloquialisms, means for recognizing an accent, means for recognizing intent of the words, means for recognizing logic, means for deciphering intent of the words, and/or means for deducing desire of the participant.

An exemplary embodiment of the present invention may include where the capture device may include a wireless transmitter and the collection device may include a wireless receiver.

An exemplary embodiment of the present invention may include where the capture device may include an encryption device adapted to encrypt the interaction prior to transmission over the wireless transmitter.

An exemplary embodiment of the present invention may include where the collection device may include a wideband receiver.

An exemplary embodiment of the present invention may include where the collection device further may include means for demodulating and filtering transmissions into separate channels.

An exemplary embodiment of the present invention may include where the capture device may include an encryption device.

An exemplary embodiment of the present invention may include where the capture device may include a storage device.

An exemplary embodiment of the present invention may include where the face-to-face interaction between two parties may include at least one of: a manager and subordinate interaction; a salesperson and customer interaction; a peer to peer interaction; a recruiter to recruit interaction; an employer and candidate interaction; a trainer and trainee interaction; a loan officer and loan applicant interaction; a human to human interaction; a commercial interaction; a business-related interaction; a non-personal interaction; a non-casual interaction; and/or a customer and employee interaction.

An exemplary embodiment of the present invention may include where the collection device may include a docking station.

An exemplary embodiment of the present invention may include where the docking station may include at least one of: a wired coupling; a wireless coupling; a cable; a port replicator; an aggregator; a single board computer; a MAC mini; a cradle; an upload device; an interface; a radio; a transmitter; a transceiver; and/or a docking device.

An exemplary embodiment of the present invention may include where the analysis system may include at least one of: means for recording the interaction; means for storing the interaction; means for indexing the interaction; means for archiving the interaction; means for training; means for marketing data capture; means for market analysis capture; means for understanding customers obviating a need for a focus group; means for scoring the interaction; means for calibrating reviews across an organization; means for normalizing across a decentralized organization; means for identifying potential marketing opportunities; means for identifying customer needs; means for identifying training needs including at least one of quantity, and/or type of training; means for measuring results of training; means for acquiring competitive intelligence; means for customer relationship management (CRM); means for analyzing customer satisfaction; means for capturing customer requirements; means for tracking compliance; means for compiling evidence of at least one of regulatory, policy, and/or legal compliance; means for tracking compliance to a process; means for tracking completion of a closed loop process; means for tracking compliance to protocol; means for tracking compliance to standard operating procedures; means for recruiting; means for monitoring employee compliance; means for employee evaluation; means for tracking compliance to best practices; means for analyzing a point of sale (POS) transaction; and/or means for tracking employee behavior.

An exemplary embodiment of the present invention may include where the analysis system is used as a processing support system for at least one of: a business; a retail sales environment; a government agency; a customer service function; a border patrol interaction; an airport interaction; a security interaction; a transportation security interaction; a border control interaction; a border agent interaction; an automotive interaction; an auto service interaction; a used auto purchase interaction; a new auto purchase interaction; a financial interaction; a banking interaction; an insurance interaction; a hospitality interaction; a health care interaction; a recruiting interaction; a military recruiting interaction; an internal revenue service (IRS) interaction; an IRS audit interaction; and/or an agency interaction.

An exemplary embodiment of the present invention may include where the analysis system may include at least one of: an application service provider; a central server; a third party server; a government server; a financial server; a bank server; a host; and/or a standalone system.

An exemplary embodiment of the present invention may include where the analysis system is owned by a first owner and the capture device and the collection device are owned by a second owner.

An exemplary embodiment of the present invention may include where the analysis system may include means for mapping the interaction to business process analytics.

An exemplary embodiment of the present invention may include where the business process analytics may include at least one of: a) receiving a process definition for a process may include: 1) receiving at least one process step of the process, and 2) receiving at least one metric relating to each of the at least one process steps, b) receiving a metric definition may include 1) receiving a rule may include at least one of: A) receiving an identification of terms recognized by a word spotting engine from a given interaction, wherein the terms are part of a predetermined term list, wherein the predetermined termlist may include a plurality of terms, B) upon the identification of at least one of existence and/or nonexistence of a given term, an event is triggered, C) upon the identification of a number of terms of a termlist falling at least one of below, within and/or above a numeric range, an event is triggered, and/or D) upon the identification of a number of terms of a termlist at least one of exceeding, reaching and/or falling below a numeric threshold, an event is triggered; c) receiving a term list definition may include a list of a plurality of terms and/or phonetics of the terms, associated with a term list; d) receiving a classification definition may include a rule regarding at least one of a numeric threshold level and/or numeric range of terms of a term list recognized by the word spotting engine about a given interaction, associated with a given classification; e) triggering an event based on a rule; f) automatically assessing an interaction based upon a metric; and/or g) automatically scoring an interaction based upon a metric.

An exemplary embodiment of the present invention may include where the business process analytics further comprise performing an automated scoring assessment of the interaction.

An exemplary embodiment of the present invention may further include scoring the interaction against a process.

An exemplary embodiment of the present invention may include where at least one of the capture device, the collection device and/or the analysis system are parts of the same device.

An exemplary embodiment of the present invention may include where the analysis system may include means for interactive access may include at least one of: a web-based interface; a graphical user interface for interacting with the interaction; a standalone application; a client/server application; an application service provider application; means for searching; means for archiving; means for reviewing business rules; means for triggering communications; means for generating an alert; means for generating a notification; means for capturing meta data; means for capturing time of day; means for capturing a point in time; means for capturing a duration of the interaction; means for filtering the interaction; means for capturing particular parties of the interaction; means for filtering out an interaction of interest from a plurality of the interactions; means for querying a database of a plurality of the interactions; means for searching for words the during the interaction; means for reviewing the interaction; means for reviewing the interaction in synchronization with a screen capture; and/or means for sending at least one of alerts, notifications, communications, and/or email.

An exemplary embodiment of the present invention may include where the analysis system may include means for processing may include at least one of: means for capturing attributes of the interaction; means for capturing audio attributes of the interaction; means for capturing video attributes of the interaction; means for capturing screen data attributes of the interaction; means for capturing temporal attributes of the interaction; means for capturing geospatial attributes of the interaction; means for capturing geographic attributes of the interaction; means for capturing location attributes of the interaction; means for capturing business attributes of the interaction; means for capturing other attributes of the interaction; means for capturing metadata attributes of the interaction; means for storing data about the interaction; means for indexing the data about the interaction; means for indexing based on at least one of location, person, event, product, time, action and/or other attribute; means for encrypting; means for decrypting; means for compressing; means for decompressing; means for coding; means for decoding; means for archiving; means for restoring; means for complying with regulatory requirements; means for complying with legal requirements; means for complying with policy requirements; means for complying with governmental requirements; means for complying with privacy requirements; means for identifying speakers; means for processing the interaction; means for improving quality of the interaction; means for removing noise from the interaction; means for dividing up conversations; means for dividing up portions of conversations; means for inserting key frames; means for inserting meta data; means for detecting emotion; means for indexing; means for tagging; and/or means for talkover.

An exemplary embodiment of the present invention may include where the analysis system is adapted for interactive access may include at least one of: web-based interface; means for listening to a conversation; means for replaying the interaction; means for accessing the interaction; means for scoring the interaction; means for evaluating the interaction; means for performing time and motion studies of the interaction; means for studying how long to qualify a customer; means for studying how long to describe at least one of a product and/or a feature; means for studying whether at least one of a feature and/or a product is discussed; means for studying the temporal length of a portion of the interaction; means for studying the length of time to take a test drive; means for studying efficiency; means for studying effectiveness; means for analyzing competitive information; means for detecting mention of a competitor's product; means for gathering market research data; means for detecting unfair trade practices; means for confirming compliance with rules; means for confirming compliance with union rules; means for gathering consumer research; means for sampling; means for asking questions; means for quantifying market data; means for collecting data; means for gathering data; means for indexing data; means for selling data; and/or means for enabling purchase of data.

An exemplary embodiment of the present invention may include a method of capturing and/or analyzing an interaction may include at least one of: a) analyzing a face-to-face interaction captured from a capture device may include: (1) receiving the face-to-face interaction from the capture device, (2) analyzing the interaction, and (3) providing interactive access to the interaction; b) capturing a face-to-face interaction for analysis at an analysis system may include: (1) capturing on a capture device a face-to-face interaction between at least two parties, and (2) transmitting the interaction to the analysis system; and/or c) collecting and analyzing a face-to-face interaction may include: (1) capturing a face-to-face interaction, and (2) analyzing the interaction.

An exemplary embodiment of the present invention may include a system where the ambulatory capture device may include, coupled to the system, at least one of: an ambulatory, portable, mobile, self-contained, dockable, digital capture device; a dockable device; a radio frequency dockable device may include at least one of a WLAN and/or a wireless ethernet communications system; a wired docking device; a microphone; an ambulatory microphone; a headset microphone; a wireless microphone; a lapel microphone; a USB microphone; a nametag microphone; an ambulatory microphone; a digital storage device; a user interface adapted to provide a recording indicator; an analog to digital (A/D) converter; secure encryption links; secure encryption while recording; a digital file-based file system; encryption; compression; a directory structure; single button start/stop recording; computing timing via realtime clock based on analysis of sampling rate; means for synchronizing time when docked; and/or means for transferring recorded data over a digital data network when docked.

An exemplary embodiment of the present invention may include a system where the collection device may include, coupled to the system, at least one of: an interface adapted to be coupled to the capture device; a universal serial bus interface (USB) interface; a data network interface; an ethernet interface; means for coupling data from the capture device to the analysis system; means for uploading the interactions; means for uploading the interactions to an application service provider; an inexpensive device; and/or means for providing secure, encrypted transmission.

An exemplary embodiment of the present invention may include a system where the analysis system may include, coupled to the system, at least one of: means for centralized analysis; means for host based backend processing; means for an application service provider (ASP) system; means for voice activated analysis; means for voice activated filtering; means for detecting voice; means for providing web access to the interaction; means for automatic gain control; means for providing playback of the interaction; means for providing playback of a snippet before and after an identified term; means for detecting silence; means for cleaning up audio; means for filtering audio; means for removing unwanted noise; means for wordspotting; means for voice recognition; means for speaker recognition; means for speech recognition; means for screen capture; means for indexing; means for capturing state of computer monitor synchronized with interaction; means for enforcing a business process; means for triggering alerts; means for enabling assessments; means for enabling scoring assessments; means for receiving a classification definition; means for receiving a term list definition; means for receiving a term definition; means for receiving a process definition; means for receiving a process step definition; means for receiving a metric definition; means for receiving a role definition; means for receiving a trigger definition; means for receiving an event definition; means for receiving a process definition may include at least one of: means for receiving a process, means for receiving at least one process step of the process, and/or means for receiving at least one metric associated with each of the process steps; means for receiving a term list definition; and/or means for identifying terms from a term list; means for identifying identified terms from a term list recognized in an interaction using a wordspotting engine; means for determining a number of identified terms appearing in a term list; means for triggering events based on a rule relating to a number of identified terms appearing in a term list; means for automatically scoring the interaction; means for automatically assessing the interaction; and/or means for classifying the interaction based on a plurality of predetermined classifications.

In an exemplary embodiment of the present invention, a system may include (for example, but not limited to) a customer interaction recordation application service provider system, which may include, in an exemplary embodiment, an ambulatory interaction capture and/or recording device adapted to record at least one recorded at least audio interaction between an employee and a customer; an aggregation device which may include a cradle or other docking device adapted to receive the recording device and transmit the captured interaction to a consolidator; an application service provider (ASP) server system including the consolidator adapted for user interactive access and analysis of the at least one recorded audio interaction; and a network coupling the aggregation device to the ASP server system adapted to transmit the at least one recorded interaction to the ASP server system upon receipt of the interaction from the capture device from the aggregator.

In another exemplary embodiment of the present invention, the system may include a capture device where the recording device is a digital recording device.

In an exemplary embodiment of the present invention, the at least one captured interaction may include a recording stored in a digital format such as, e.g., a WAV, OGG, an MP3, or other encoded compression format.

In yet another exemplary embodiment of the present invention, the system may further include a voice recognition system adapted to analyze the at least one audio interaction performing speech recognition, wordspotting, and/or speaker recognition.

In another exemplary embodiment of the present invention, a method for providing recordation and training of a customer interaction may include (for example, but not limited to): (a) receiving at an application service provider (ASP) at least one captured (at least audio) interaction between an employee and a customer, transmitted over a network to the ASP consolidator upon coupling to or placement in of a capture device in a cradle or aggregator, the capture device being adapted to record the at least one digital audio interaction; (b) analyzing the at least one audio interaction; and (c) providing interactive user access, annotation, playback and/or assessment of the at least one audio and/or video interaction.

In another exemplary embodiment of the present invention, a method of capturing an employee interaction with a customer for training purposes may include (for example, but not limited to): (a) capturing or recording at least one audio interaction between an employee and a customer on an ambulatory capture digital recording device; and (b) transmitting, upon placement of the ambulatory capture digital recording device in a cradle, the at least one recorded audio interaction over a network to an application service provider (ASP) server system adapted for user interactive access and analysis of the at least one recorded audio and/or video interaction.

Further features and advantages of the invention, as well as the structure and operation of various exemplary embodiments of the invention, are described in detail below with reference to the accompanying drawings.

### BRIEF DESCRIPTION OF THE DRAWINGS

The foregoing and other features and advantages of the invention will be apparent from the following, more particular description of an embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts a view of an exemplary system architecture for capturing, collecting and analyzing recorded interactions according to an exemplary embodiment of the present invention;

FIG. 2 depicts an exemplary view of an exemplary single board computer (SBC), or exemplary aggregation device, according to an exemplary embodiment of the present invention;

FIG. 3A depicts an exemplary view of various exemplary recording devices including digital storage devices and various exemplary microphones, according to an exemplary embodiment of the present invention;

FIG. 3B depicts an exemplary view of other exemplary digital recording devices according to an exemplary embodiment of the present invention;

FIG. 3C depicts an exemplary view of other exemplary recording devices including exemplary personal digital assistant (PDA) and handheld computer embodiments according to an exemplary embodiment of the present invention;

FIG. 4 depicts an exemplary view of an exemplary software screenshot of an interactive portal application for, e.g., but not limited to, accessing, viewing, managing, querying, searching and/or playing captured interactions, according to an exemplary embodiment of the present invention;

FIG. 5 depicts an exemplary view of an exemplary computer system as may be used in implementing an exemplary embodiment of the present invention;

FIG. 6A depicts an exemplary view of an exemplary aggregator software application flow diagram, which may prepare captured audio files for transfer to a central server for analysis, according to an exemplary embodiment of the present invention;

FIG. 6B depicts an exemplary view of an exemplary aggregator application software in an exemplary cache mode, including an exemplary process flow diagram according to an exemplary embodiment of the present invention;

FIG. 6C depicts an exemplary view of an exemplary aggregator application software in an exemplary encode mode, including an exemplary process flow diagram according to an exemplary embodiment of the present invention;

FIG. 6D depicts an exemplary view of an exemplary aggregator application software in an exemplary transfer mode, including an exemplary process flow diagram, according to an exemplary embodiment of the present invention;

FIG. 7A depicts an exemplary view of an exemplary consolidator application software flow diagram, which may make recorded interaction files accessible from web based application portal, according to an exemplary embodiment of the present invention;

FIG. 7B depicts an exemplary view of an exemplary flow diagram of an exemplary consolidator application software flow diagram, which may prepare and process uploaded encoded audio files, to allow playback, review and/or assessment, according to an exemplary embodiment of the present invention;

FIG. 8 depicts an exemplary view of an exemplary indexer software application process flow diagram, which may process wordspot results, and generate exemplary audio thumbnails, according to an exemplary embodiment of the present invention;

FIG. 9 depicts an exemplary view of an exemplary word spotting process flow diagram, which may be used to perform digital signal processing, word spotting from a word spot dictionary, clean up, executing wordspotting based on wordspot lists, according to an exemplary embodiment of the present invention;

FIG. 10 depicts an exemplary view of an exemplary web-based access, management, and playback portal including various exemplary login, sessions, playback, assessment, alert, process editor, reporting, administration, usage and monitoring, according to an exemplary embodiment of the present invention;

FIG. 11 depicts an exemplary view of an exemplary graphical user interface (GUI) screenshot of an exemplary sessions page, which may indicate a list of exemplary recorded interactions accessible, for further analysis and/or playback, according to an exemplary embodiment of the present invention;

FIG. 12 depicts an exemplary view of an exemplary screen shot of an exemplary playback screen graphical user interface (GUI), which may indicate various exemplary bookmarks, playback control buttons, zoom, volume and automatic gain control, according to an exemplary embodiment of the present invention;

FIGS. 13A-13C depict several exemplary views of an exemplary screenshot of an exemplary assessment page for assessing a captured interaction, which may include multi-part questions, comment fields, scoring, and total scores, according to an exemplary embodiment of the present invention;

FIG. 13D depicts an exemplary view of an exemplary screen shot of an exemplary completed assessment according to an exemplary embodiment of the present invention;

FIG. 14A depicts an exemplary view of an exemplary alerts page, which may trigger alerts based on identification from word-spotting of particular terms on an exemplary term list, according to an exemplary embodiment of the present invention;

FIG. 14B depicts an exemplary view of an exemplary alert page including an exemplary term list for triggering the exemplary alert, according to an exemplary embodiment of the present invention;

FIG. 15 depicts an exemplary view of exemplary screen shot views of an exemplary business process automation system, allowing adding a measure to trigger an alert upon satisfaction of exemplary criteria, and updating measures, according to an exemplary embodiment of the present invention;

FIG. 16A depicts an exemplary view of exemplary screen shot views of an exemplary user management system, allowing assigning roles, adding new roles, updating a user record, according to an exemplary embodiment of the present invention;

FIG. 16B depicts an exemplary view of exemplary screen shot views of an exemplary user management system, allowing assigning users to organizational units, according to an exemplary embodiment of the present invention;

FIG. 17A depicts an exemplary view of exemplary screen shot views of an exemplary classification system, set up terms, phonetic settings for term lists, according to an exemplary embodiment of the present invention; and

FIG. 17B depicts an exemplary view of exemplary screen shot view of an exemplary term list update system, allowing selecting terms from a list of available terms to create classifications, including setting thresholds to qualify a session as meeting a particular classification, according to an exemplary embodiment of the present invention.

### DETAILED DESCRIPTION OF EXEMPLARY EMBODIMENTS OF THE PRESENT INVENTION

Various exemplary embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention.

Technology Overview Description

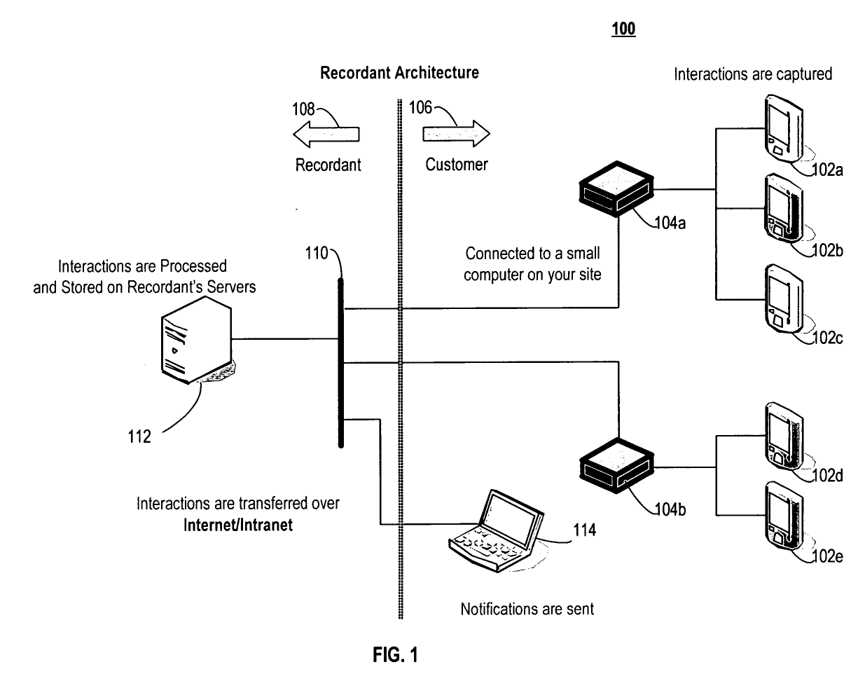

The present invention enables companies who engage in face-to-face interactions with customers on their premises, such as, e.g., but not limited to, retail stores, banks, and/or hotels, etc., to record, access, analyze and use employee/customer interactions for such useful purposes as training, compliance, etc. An exemplary, non-limiting example, of the technology according to an exemplary embodiment of the present invention is the SoundMirror™ Application Software System available from RECORDANT™, INC., a Delaware Corporation of 590 Means Street, Suite 200, Atlanta, Ga., 30318 U.S.A. According to an exemplary embodiment, using an offering from RECORDANT, entitled FRONTLINE INTERACTIONS™, a company may use a recorded audio captured interaction of the customer interaction recorded on a capture device 102, as shown, e.g., in FIG. 1, for aggregation via an aggregator such as a single board computer (SBC) 104 for collection and transmission to a backend concentrator server 112 for analysis, and application service provider (ASP) processing including to deliver such exemplary services as, e.g., but not limited to, analyzing, training, converting and/or translating the recorded interaction into actionable intelligence. In an exemplary embodiment, an audio interaction may be recorded and analyzed. In another exemplary embodiment, an audio and/or a video interaction may be recorded for further analysis. In another exemplary embodiment of an offering from RECORDANT, INC., entitled INTERACTION INTELLIGENCE™, actionable intelligence, obtained from translation and/or analysis of the face-to-face employee customer interaction, may be used to, e.g., but not limited to, drive sales, service, customer satisfaction, operating efficiencies, and/or shareholder value, etc. In another exemplary embodiment, other types of face-to-face interactions may be captured, according to the present invention, using the ambulatory capture device 102, aggregator 104, and consolidator 112, including a manager to employee, recruiter to prospect, retailer to customer, government agency to constituent, according to exemplary embodiments of the present invention.

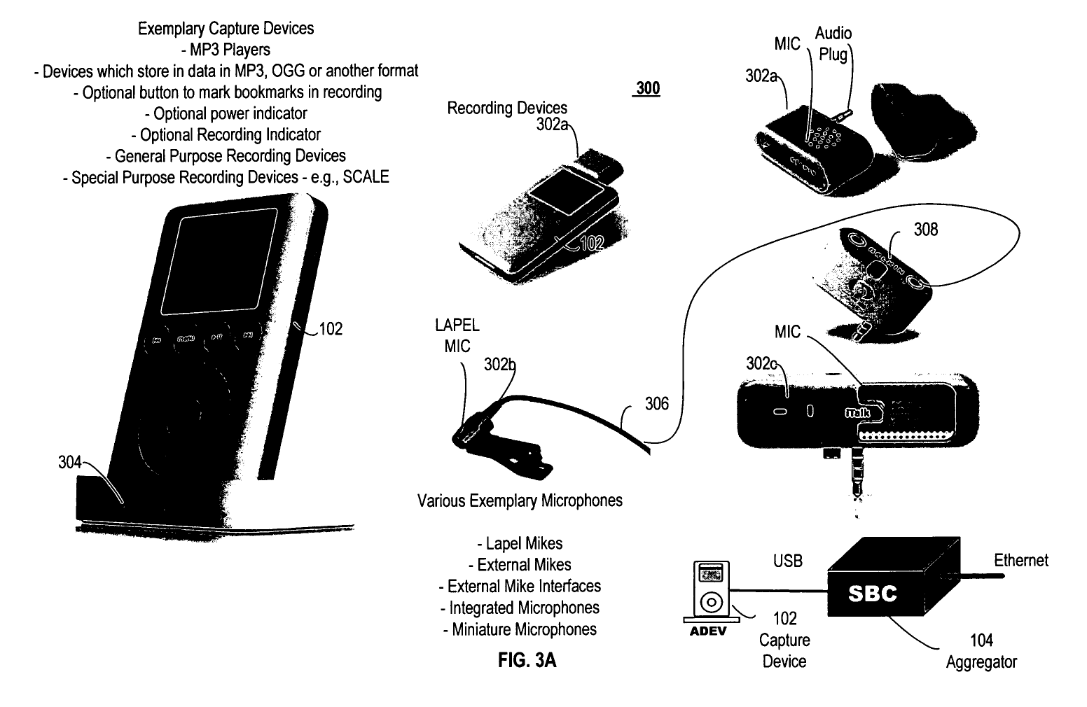

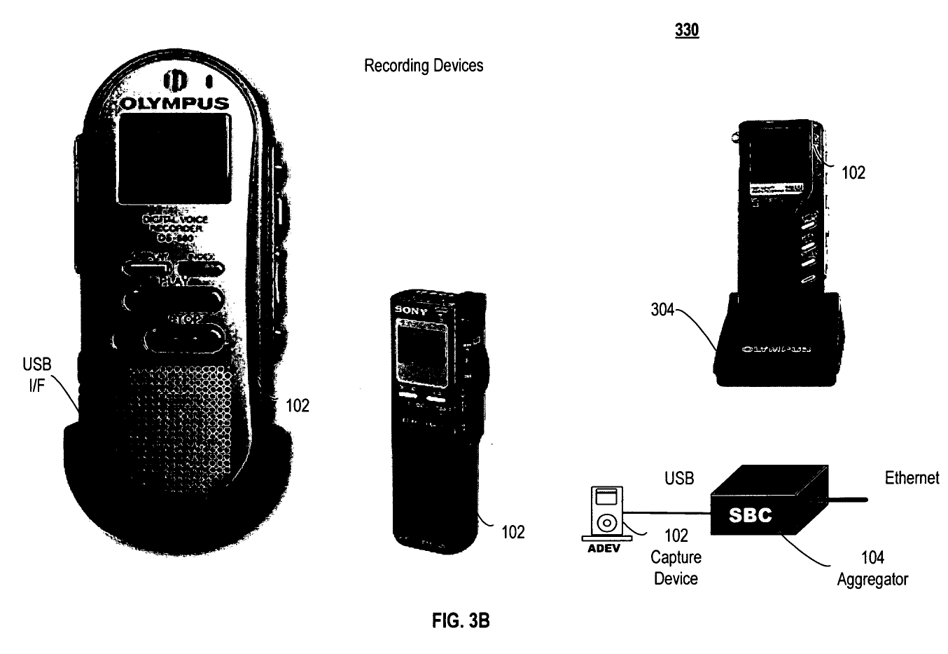

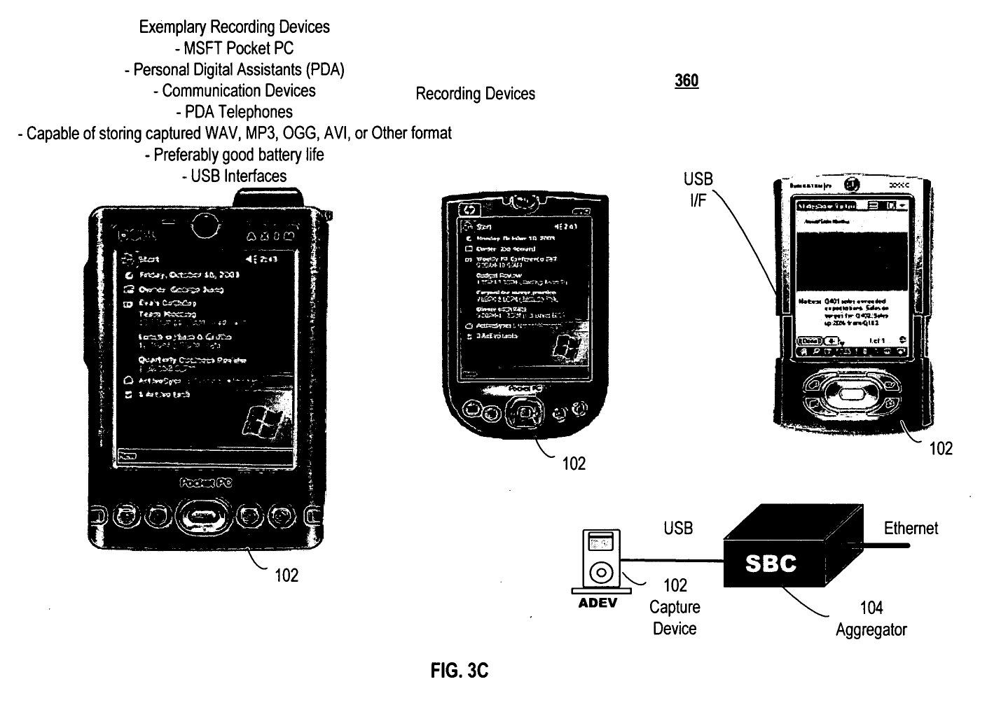

As illustrated in FIG. 1, employees, or others involved in a face-to-face interaction, according to an exemplary embodiment of the present invention, may wear a small, unobtrusive ambulatory audio (and/or audio and video, etc.) recording device 102 that may record the audio (and/or video, etc.) interactions between the employee and customers. The recording device, referred to as capture device 102a-102e may, according to an exemplary embodiment, be similar to, e.g., but not limited to, a small personal digital assistant (PDA), recorder, MP3 digital recorder, or iPod® device, available from APPLE COMPUTER CORPORATION of Cupertino, Calif. U.S.A., as shown in FIG. 3 (FIGS. 3A, 3B, and 3C, collectively). In alternative exemplary embodiments, the capture device 102 may include, e.g., but not limited to, a miniature device, and/or a combination recording device and other functional device. For example, according to an exemplary embodiment of the present invention, the device may be available as, e.g., but not limited to, a name tag, a pen, a pencil, other writing instrument, a hidden camera, surveillance camera, a special purpose wiretap device such as, e.g., a SCALE available from Digital Audio Corporation, Durham, N.C. USA, a VOCERA wireless badge available from Vocera Communications of Cupertino, Calif. USA, etc. According to an exemplary embodiment of the present invention, at the end of a workday, employees may cradle or otherwise dock or couple the ambulatory capture and/or recording device 102a-e, e.g., but not limited to, similar to the way a PDA may conventionally be cradled or docked, via, e.g., but not limited to, a universal serial bus (USB) port, or the like to an aggregation device 104 (104a, 104b, collectively). According to an exemplary embodiment, the aggregation device 104 may transmit the captured interactions to a consolidator application server 112, which may be a centralized, hosted application of a service provider, such as, e.g., but not limited to, an application service provider (ASP), or other service provider, etc., which may in an exemplary embodiment, provide the aggregation device 104 and/or cradling/docking device 304 and/or capture device 102 as part of a service offering. The recorded captured interactions may, according to an exemplary embodiment, be transmitted via a network 110, such as, e.g., but not limited to, the Internet, to a consolidator application server device 112 coupled to the network 110, which may be adapted to analyze, store, and/or provide access to, playback, scoring, assessment and reporting of the captured interactions. According to an exemplary embodiment, the device receiving the interactions may be a hosted ASP, or other corporate host server. According to another exemplary embodiment, the recording device 102 may, e.g., but not limited to, be docked, and/or otherwise coupled to, e.g., but not limited to, a storage, analysis and/or access device, for further processing.

According to an exemplary embodiment of the present invention, customers (i.e., companies, retail firms, etc.) of the service provider may subscribe to, e.g., but not limited to, an ASP-delivered software service, which may in an exemplary embodiment, be delivered via, e.g., the world wide web, or other browser, or application. The software service, according to an exemplary embodiment of the present invention, may permit users, i.e., the customers (i.e., the companies, the retail firms, etc.) of the service provider to, e.g., but not limited to, access, playback, and score/assess interactions, obtain intelligent evaluation forms, evaluate employee performance, use tools to perform business analytics, review alerts, wordspots identified with voice recognition, and/or obtain statistical and/or other reports, etc.

Customers (e.g., companies, retail firms, etc.) of the service provider may require nothing more than a browser such as, e.g., but not limited to, an Internet web browser, to access an interactive portal application or applet from the service provider host, allowing access and playback of the recorded interactions, evaluation, assessment and/or scoring tools, analysis/comparison/trending tools, and/or reports.

According to an exemplary embodiment of the present invention, Interaction Intelligence Reports™, an exemplary service offering, may, for the first time, provide insight, to the customers of the service provider, into face-to-face ambulatory customer interactions, and can enable customers of the service provider to make decisions that, e.g., but not limited to, can improve and/or control sales, up-sales, cross-sales, affinity sales, customer service, reduced returns, problem resolution, faster and/or more efficient, customer processing, manager evaluation consistency, training resource utilization merchandising strategies, competitive data gathering, and/or in-store interaction tactics.

Another service offering, according to an exemplary embodiment of the present invention, which may be entitled Frontline Interactions™—the interpersonal “dialogue” between customers and a storefront company—may, in an exemplary embodiment, be the bearing point that may drive all other business process gears within the enterprise. The absence of Frontline Interactions™ or the presence of defects within the interactions observed can reverberate havoc through an enterprise's internal workings and outputs—including, e.g, but not limited to, spiraling costs, lowering revenues, and/or decreasing shareholder value.

Back-End Analytics—Customer Interaction Business Process Solution (CIBP™) Two General Functionality Categories

The software, according to an exemplary embodiment of the present invention, may include, e.g., but not limited to, alone, and/or in combination with the other listed technologies, may perform the following functions:

1. Customer Interactions

According to an exemplary embodiment of the present invention, customer interactions may, e.g., but not limited to, capture, record, measure, analyze, control, provide interactive access, playback and assessment of, and/or report on customer interactions where those interactions may occur face-to-face between on the one hand, e.g., but not limited to, a firm's and/or organization's employees and/or contractors and on the other hand, their customers and/or prospective customers. In another exemplary embodiment, other face-to-face interactions such as, e.g., manager to employee, recruiter to candidate, service provider to customer, etc., may according to the present invention be accessed and analyzed. These functions may occur, e.g., in any setting where the interaction is, or may be, live and/or face-to-face between the parties. According to an exemplary embodiment of the present invention, low cost, portable, ambulatory capture devices may be used to allow capture of face-to-face interactions in environments which have never been possible before. Examples of settings can include, e.g., but are not limited to, retail, banking, hotel and/or hospitality, car rental, air lines, check-in counters, walk-in centers, walk up windows, in private and/or public meeting rooms—essentially anywhere there is, or may be, a live face-to-face interaction between two individuals engaged or who may be engaged to discuss a business transaction and/or potential business transaction between the engaged parties and/or the firms each may represent, etc. The term “business” here may refer to, according to an exemplary embodiment of the present invention, for profit, not-for-profit, civil, public, quasi-public, and/or government. Customer interactions may include, e.g, but not limited to, the audio between the parties, and may include other media, related to those audio (and/or video) interactions including, but not limited to, e.g., data, which may be, e.g., visually presented such as, e.g., but not limited to, on a PC monitor, Kiosk, teller machine, dumb terminal, and/or other electronic or other display device. For example, a screen of, e.g., a point of sale (POS) terminal display, a loan officer's computer monitor, etc., may be captured in synchronization with the capture of an associated face-to-face interaction, in one exemplary embodiment.

2. Customer Interaction Business Processes

According to another exemplary embodiment of the present invention, customer interaction business processes, may automate, e.g., human (manual) business processes and/or may integrate with, e.g., human business processes that are, may, or can be associated with, e.g., but not limited to, according to an exemplary embodiment, the defining, creating, observing, evaluating, measuring, analyzing, coaching, controlling, producing, and/or implementation of customer interactions, etc., where those associated customer interactions are, or may be, live face-to-face between parties engaged in the conduct of business. In another exemplary embodiment, the interaction may be delayed, or may be via, e.g., but not limited to, a collaborative environment such as, e.g., a video conference. The “parties” may, in an exemplary embodiment, be defined to include customers and/or potential customers, and employees who are, or may be, engaged with customers (and thus may include, e.g., but not limited to, interactions between employees and/or between employees and prospective employees who could be engaged with customers).

Description of Customer Interaction Business Process Functionality

The Customer Interaction Business Process Software Solution (CIBPSS), according to an exemplary embodiment of the present invention, may perform exemplary business process functions described below and/or shown in the appended drawings. The CIBPSS may do so by, e.g., but not limited to, coding human processes associated with customer interactions into software, sometimes “re-engineering” those human processes for the purpose of making them more effective and efficient. The encoded processes and their performance may, in an exemplary embodiment include, e.g., but not limited to, industry standard processes, and/or additional proprietary processes.

Observation of Customer Interactions

The Recordant solution, according to an exemplary embodiment, may, e.g., but not limited to, according to an exemplary embodiment of the present invention, “observe” recorded customer interactions, such as, e.g., but not limited to, recorded interactions such as, e.g., but not limited to, audio (and/or video, etc.) interactions, which may be recorded in, e.g., but not limited to, a digital (or other) format such as, e.g., but not limited to, MP3, OGG, WAV, MPEG, AVI and/or another format, including, e.g., compressed, uncompressed, encrypted and/or unencrypted, etc. The solution may assign attributes (such as, e.g., but not limited to, metadata) to the interactions including, but not limited to, such information as, time and/or duration of the interaction, how long a recorded employee (such as, e.g., but not limited to, a sales or service rep) may have been working at the time of the interaction, and/or words, phrases, and/or sentences which may have been spoken (gestured, or otherwise indicated) during the interaction as may be determined by wordspotting using voice recognition including e.g., but not limited to, speech recognition and/or speaker recognition. The Recordant system may also, according to an exemplary embodiment of the present invention, assign any other number of attributes to the recorded/captured interactions. The solution, according to an exemplary embodiment of the present invention, may use programmed business rules, may identify and/or select, e.g., but not limited to, recorded interactions and, may, using business rules, etc., route the recorded interactions to pre-selected agents such as, e.g., but not limited to, humans, and/or non-human agents, for, e.g., but not limited to, evaluation and/or other business purposes, etc. Automated software agents may alert a user upon occurrence, or lack thereof, of particular business process milestones.

Observation of Employee Management

The Recordant solution, according to an exemplary embodiment of the present invention, may “observe” employee managers. The solution, according to an exemplary embodiment, may measure manager performance such as, e.g., (but not limited to) the frequency with which managers may evaluate their employee's customer interactions, the consistency with which managers may evaluate their employees interactions, as compared with the way other managers may evaluate the same employees (or others), and the evaluation scores managers' employees may obtain compared to other managers' employees' scores. The Recordant system may also, e.g., but not limited to, assign any other number of attributes to the managers. The solution, may use, e.g., but not limited to, programmed business rules, may identify and/or may select manager information such as, e.g., but not limited to, metadata, and/or may use business rules, which may route the recordings, to, e.g., but not limited to, humans, pre-selected humans, and/or other agents, including non-human agents, for, e.g., but not limited to, evaluation and/or other business purposes, etc.

Evaluating—Evaluation Documents

The Recordant solution, according to an exemplary embodiment of the present invention, may automate the process of creating employee and manager evaluation tools and/or forms. The forms, in an exemplary embodiment, may be generated, e.g., but not limited to, automatically from, e.g., a software driven tool, which may be called a “Customer Interaction Business Process Architecture™” document and/or “Customer Interaction Business Process Architecture and Policy™” document, according to an exemplary embodiment of the present invention. The documents may define customer interaction business processes and may create and/or assist in the creation of metrics. According to an exemplary embodiment of the present invention, Situational Interaction Protocols™ (SIP™) and/or Key Interaction Indicators™ (KII™) may include, e.g., but not limited to, two proprietary processes and/or factors, which may be incorporated in creation of, e.g., the “Architecture” document of the “Forms”. Assessment and scoring tools may allow a reviewer of captured interactions to score a given interaction. The scoring may be manual, automated, and/or semi-automated and rules based according to certain analytics.

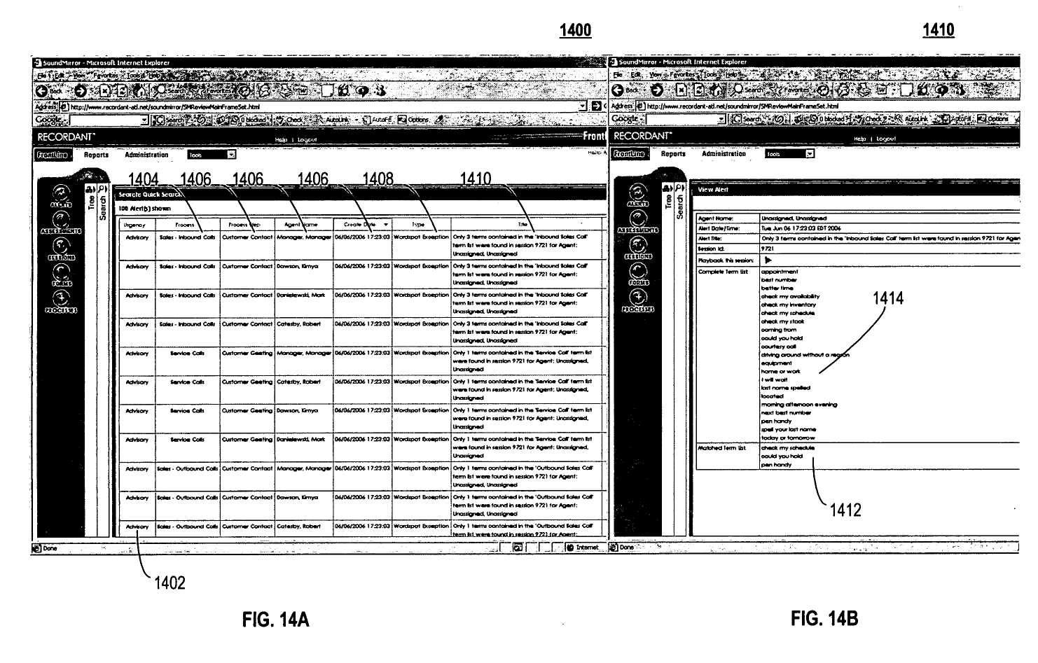

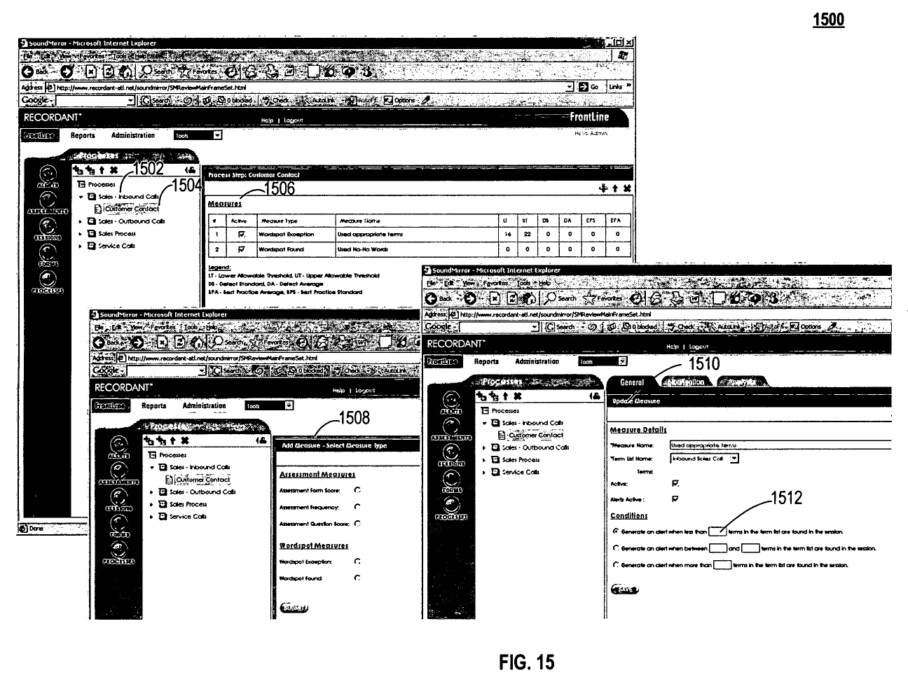

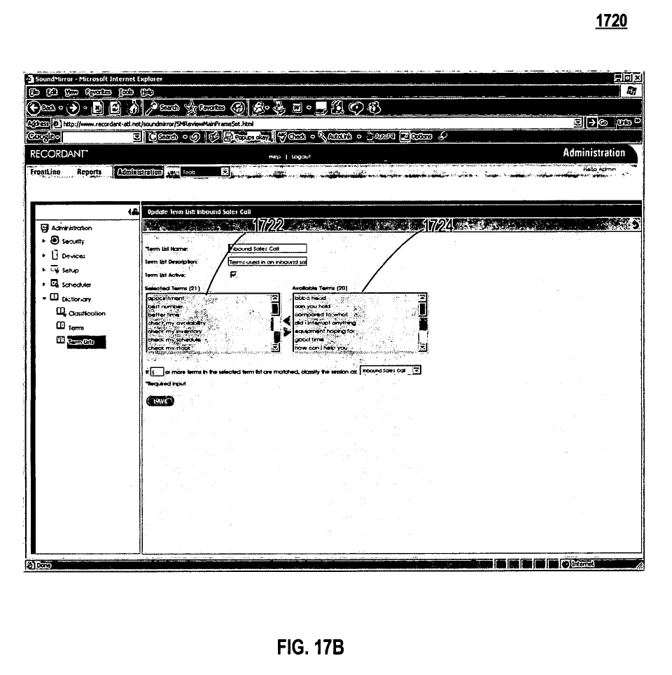

According to an exemplary embodiment of the invention, a business process may be defined, along with metrics which may be used to perform automated classification of interactions, as well as automated assessment and/or scoring. In an exemplary embodiment, a process may be defined (see the discussion with reference to FIG. 15 below). In an exemplary embodiment, one or more new processes may be defined. Each new process may include, in an exemplary embodiment, one or more process steps. Each process step, according to an exemplary embodiment, may include one or more measures or metrics. In an exemplary embodiment, a measure or metric may include a rule, which may include, e.g., but not limited to, whether a metric was satisfied, such as, e.g., whether something desired was achieved, or accomplished, or whether something not desired, was avoided or not undertaken, etc. In an exemplary embodiment, an interaction may be processed to identify words using, e.g., but not limited to, a wordspotting engine as discussed below, in an exemplary embodiment. In an exemplary embodiment, prior to wordspotting, terms to be identified may be created (see FIG. 17A, for example, below) and groups of terms referred to as term lists may also be defined (see FIG. 17B, for example, below). In an exemplary embodiment, lists of one or more terms, referred to herein as termlists may be created. In an exemplary embodiment, rules may be defined as metrics which may determine whether or not one or more desirable terms in a termlist were identified, or whether or not undesirable terms were identified. In an exemplary embodiment, an AUDIO THUMBPRINT™, i.e., a snippet of audio surrounding the identified term may be provided to a review to allow replay and understanding of context of the identified term during playback. In an exemplary embodiment, rules may be defined as metrics which may determine whether a threshold number was reached or exceeded of a plurality of desired terms in a termlist were recognized, whether a number within a desired or undesired range of a plurality of terms in a termlist were recognized, whether less than a desired number of terms was reached, whether greater than a desired amount of undesired words were recognized, etc. In an exemplary embodiment, rules may be created that may trigger alerts (see discussion below with reference to FIGS. 14A and 14B, for example), based on a rule or metric. In an exemplary embodiment, metrics may be created that may be used to classify (see FIG. 17A below) an interaction such as, e.g., but not limited to, if greater than, e.g., 5 terms are identified from a sales call term list of, e.g., 25 terms, then the interaction may be categorized as a sales call type interaction, etc. In an exemplary embodiment, using such metrics, rules, processes and predefined terms, termlists and classifications, the system may, in an exemplary embodiment, automatically and dynamically, via, e.g., data mining analytics, evaluate an interaction, assess an interaction against predefined rules, may classify an interaction, may score the interaction against metrics, and/or may trigger alerts based on results of the analyses.

Evaluating—Employee and Manager Evaluation

The system, according to an exemplary embodiment of the present invention, may automatically evaluate, e.g., but not limited to, employee and/or manager performance with respect to, e.g., but not limited to, use of words, phrases, and/or sentences and/or may, e.g., but not limited to, assign scores based upon that performance. The system may also automatically generate, e.g., according to an exemplary embodiment of the present invention, evaluation forms—forms, which in an exemplary embodiment the system may automatically generate from, e.g., but not limited to, the “Customer Interaction Business Process Architecture™” document—for managers and/or other employees, etc., to use to, e.g., evaluate, e.g., but not limited to, customer interaction performance for, e.g., but not limited to, a selected interaction situation (i.e., e.g., but not limited to, the “Situational Interaction Protocol™”.) Compliance to government, legal, regulatory, corporate and/or internal procedural guidelines may be assessed and scored, according to an exemplary embodiment. Wordspotting may be used including voice recognition to automate some scoring and evaluation of captured interactions, in an exemplary embodiment.

Evaluating—Electronic Forms

Employees/Managers, according to an exemplary embodiment of the present invention, can click on form fields to be linked to the underlying “Customer Interaction Business Process Architecture and Policy™” document and may glean what may, in an exemplary embodiment, be underlying the purpose of the field in question or the evaluation form in general.

Coaching—Automated Coaching

The Recordant solution, according to an exemplary embodiment of the present invention, may provide for recording of managers' coaching of their employees. Recorded coaching interactions may be, e.g., but not limited to, a process similar to the ways employee interactions may be processed, e.g., but not limited to, as described in “Observation” and “Evaluation,” described above.

Coaching—Best Practices

According to an exemplary embodiment of the present invention, the system may, based upon, e.g., but not limited to, performance scores or transactional results obtained from sources external to the Recordant system, may identify, e.g., but not limited to, audio clips, etc., from interactions and from coaching sessions that may meet best practices standards and may store them in “Best Practice” locations such as, e.g., but not limited to, in manager and/or executive folders.

Other Functions

The system, according to an exemplary embodiment of the present invention, may perform Observation and/or Evaluation functions, etc., on, e.g., but not limited to, customer's audio responses to employees' audio dialogue.

The system may perform, e.g., but not limited to, a statistical correlation between, e.g., the metrics (KII™) from interactions and, e.g., the metrics of a firm's transactions. The purpose may, in an exemplary embodiment, be to provide predictive capabilities and/or decision support to managers, etc.

The system, according to an exemplary embodiment of the present invention, may automatically generate “Customer Interaction Alerts”. That is, based upon measured performance, and the variance of that performance from firm's standards and/or averages, may issue, e.g., but not limited to, via email, instant message, page, alert, notification, and/or another communication, etc., a Customer Interaction Alert™ and may route the communication to designated employees and/or management.

FIG. 1 depicts an exemplary view of a diagram 100 of an exemplary system architecture for capturing, collecting and analyzing recorded interactions according to an exemplary embodiment of the present invention. Diagram 100 includes a plurality of capture devices 102a-102e coupled, in an exemplary embodiment to aggregation devices 104a, 104b via a wired or wireless coupling such as a docking station or universal serial bus (USB) cable. Capture device 102 may include, in an exemplary embodiment, a recording device; a digital device; a wired device; a wireless device; a microphone; a fixed microphone; a portable microphone; a headset capture device; a device that is worn by a user; a device including a radio transmitter; a video camera; an audio capture device; a video capture device; a portable device; an embedded device; a computing device; a communications device; a personal digital assistant (PDA); a handheld device; a pocket PC device; a synchronized device; a witnessed interaction subsystem; a telephony recording device; an audio recording device; a video recording device; a telephony device; a lapel microphone device; a wireless telephony device; a wireless LAN device; a wiretap; a device embedded in clothing; a concealed device; a point of sale (POS) device; a digital audio device; a digital video device; and/or an analog device and an analog to digital conversion device.

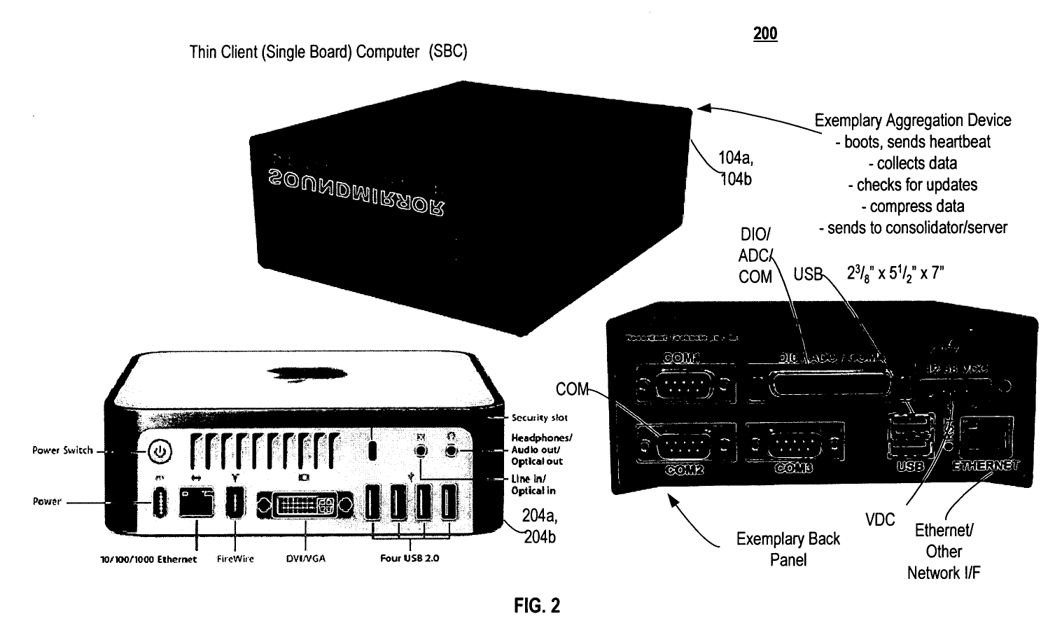

According to an exemplary embodiment, aggregation devices 104a, 104b may be a single board computer (SBC), or the like, such as a MAC MINI available from Apple Computer. See the discussion below with reference to FIG. 2 for an exemplary embodiment of aggregation device 104.

Aggregation devices 104a, 104b, according to an exemplary embodiment, may be coupled via a network 110 to one or more server devices 112, as shown. According to an exemplary embodiment, server 112 may be an application server and may include one or more web servers, as well as database servers, according to an exemplary embodiment.

Server 112, according to an exemplary embodiment, may include a process referred to as consolidator, which may analyze captured face-to-face interactions including, e.g., word spotting, indexing, voice recognition (including speech recognition and/or speaker recognition), metadata, business process analytics. Server 112 may analyze interactions and data and may provide to a user 114 user interactive access and playback of the captured interactions, and may provide reports, as well as enabling scoring/assessment and sending of alerts, and notifications, upon occurrence of criteria. According to one exemplary embodiment, a customer may have the capture devices 102, and aggregation devices 104 at the customer location 106, whereas the application service provider (ASP) server 112 may be located at a service provider central site 108, or datacenter, according to an exemplary embodiment.

FIG. 2 depicts an exemplary view 200 of an exemplary aggregation device 104 including an exemplary single board computer (SBC) 104a, 104b. Exemplary aggregation device 104, according to an exemplary embodiment of the present invention, may include basic functionality which may boot, may send a heartbeat to a central server 112, may collect data, such as, e.g., but not limited to, identifying newly recorded captured interactions, may check for updates, may compress data, and may forward the data to a consolidator application at server 112. According to one exemplary embodiment, the aggregation device 104 may be a general purpose, and/or a special purpose computer and/or communication capable device. In an exemplary embodiment, on the lower right side, a device may be provided with one or more communications ports such as, e.g., but not limited to, a universal serial bus (USB) port, an RS-232C serial interface communications interface, an audio to digital conversion port, a power DC voltage (VDC) port, a network interface (NIC I/F) such as ethernet, etc. According to another exemplary embodiment, on the lower left, a MAC MINI 204a, 204b may be provided with a power interface, power switch, ethernet NIC interface, a firewire interface, a DVI/VGA video port, one or more USB ports (4 in an exemplary embodiment), a line in/optical in, and headphones/audio out/optical out, as well as a security slot.

FIG. 3A depicts an exemplary view 300 of various exemplary recording capture devices 102 including digital storage devices 102 and various exemplary microphones 302a-c, according to an exemplary embodiment of the present invention. Exemplary capture device 102 may include an iPOD™ devices available from Apple Computer, which may be dockable via a dock 304, as shown in an exemplary embodiment on the left side of the figure. According to an exemplary embodiment of the present invention, exemplary capture devices 102 may be digital recording devices, MP3 players, devices which may store data in any of a number of digital formats including, e.g., but not limited to MP3, OGG, WAV, MPEG, AVI, or any other format. According to an exemplary embodiment of the present invention, exemplary capture devices 102 may include an optional button to mark bookmarks in a recording, may include an optional power indicator, an optional recording indicator, may include general purpose recording devices, and/or special purpose recording and/or wireless communication devices such as, e.g., but not limited to, SCALE, VOCERA, etc. According to an exemplary embodiment of the present invention, exemplary capture devices 102 may as shown in the top center may include an audio microphone 302a as shown separately in the upper right with a microphone and audio plug for coupling to the recording device 102 as shown. According to an exemplary embodiment of the present invention, exemplary capture devices 102 may include an external microphone adapter 308 for coupling an external microphone such as, e.g., but not limited to, a lapel microphone 302b coupled by cable 306. According to an exemplary embodiment of the present invention, exemplary capture devices 102 may, be coupled to an external microphone 302c and may be coupled to, e.g., but not limited to, lapel mikes, external mikes, external mike interfaces, integrated microphones, miniature microphones, etc. According to an exemplary embodiment of the present invention, exemplary capture devices 102 maybe coupled, as shown in the lower right hand corner, via a USB or other interface to aggregator 104, which may in turn communicate to network 110 (not shown), via an Ethernet or other NIC interface as shown in an exemplary embodiment.

FIG. 3B depicts an exemplary view 330 of other exemplary digital recording capture devices 102 according to an exemplary embodiment of the present invention. According to an exemplary embodiment of the present invention, exemplary capture devices 102 may include digital audio recording devices as shown, which in an exemplary embodiment, may include a USB interface, and/or a dock 304.

FIG. 3C depicts an exemplary view 360 of other exemplary recording capture devices 102 including an exemplary personal digital assistant (PDA) and handheld computer embodiments, including Pocket PC™ available from Dell, Hewlett Packard, and/or Palm, according to an exemplary embodiment of the present invention. Other devices not shown, which may be used according to an exemplary embodiment, may include PDA telephones, wireless telephony devices, capture devices 102 capable of storing captured WAV, MP3, OGG, AVI, or other formats, preferably devices with good battery life, and may include, in an exemplary embodiment, a USB interface for coupling to the network 110.

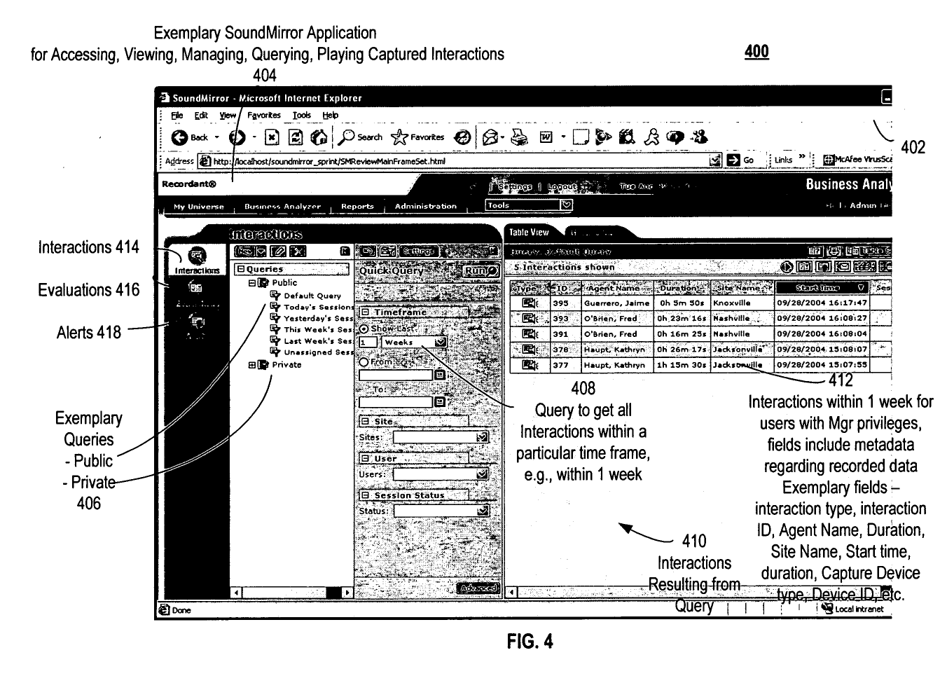

FIG. 4 depicts an exemplary view of an exemplary software screenshot 404 of an exemplary graphical user interface (GUI) of an interactive portal software application 402 for, e.g., but not limited to, accessing, viewing, managing, querying, searching and/or playing captured interactions by a user, according to an exemplary embodiment of the present invention. Portal 102, according to an exemplary embodiment may be web-based and may have the service provider's logo 404, or may include a customer's logo skin on the GUI. Along the left hand side of the portal 102, according to an exemplary embodiment, may be included one or more tabs such as, e.g., but not limited to, interactions 414, evaluations 416, and alerts 418, as may be accessed by the user, according to the privileges of the user. Under interactions tab 418, according to an exemplary embodiment, a user may have various public, as well as private queries 406. An exemplary query 408 may be customized to find/access all captured interactions within a particular time frame, e.g., within 1 week, to which the user is permitted access. Exemplary interactions found resulting from the query 408 may be shown in panel 410, according to an exemplary embodiment. Each interaction resulting from the query may include a record 412 of various exemplary fields as shown, including, e.g., in an exemplary embodiment, a type of interaction (e.g., audio, etc.), an identifier (ID), an agent name associated with the capture device 102 from which the interaction was captured, a site name including an organizational unit of which the user is associated, a start time of the captured interaction, a duration, any annotations, etc. Other fields may include a capture device 102, a device ID, a device type, etc.

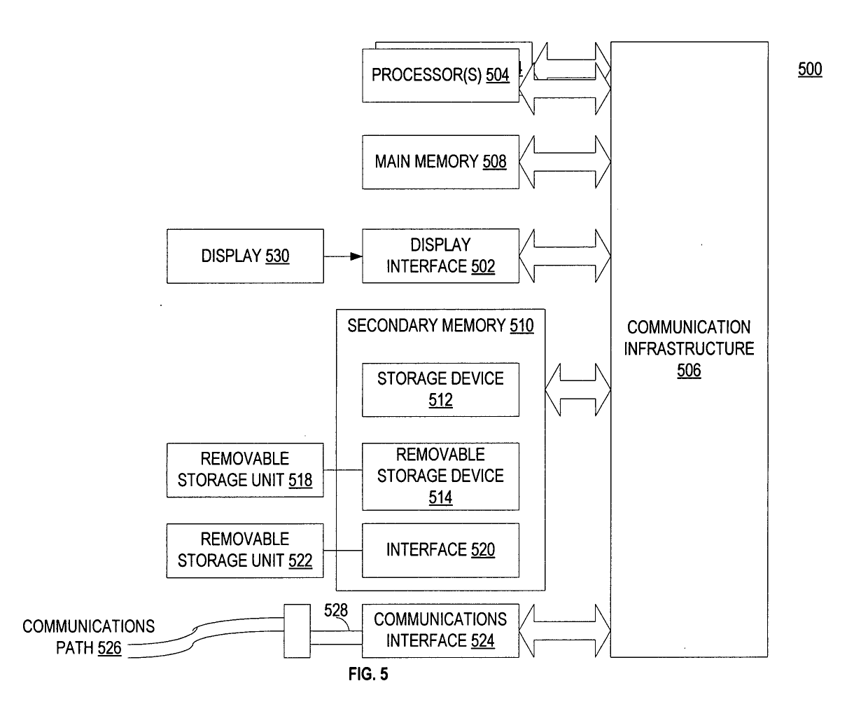

FIG. 5 depicts an exemplary view 500 of an exemplary computer system 102, 104, 112 as may be used in implementing an exemplary embodiment of the present invention. FIG. 5 depicts an exemplary embodiment of a computer system that may be used in computing devices such as, e.g., but not limited to, capture device 102, aggregation device 104, and/or server/consolidator device 112 according to an exemplary embodiment of the present invention. FIG. 5 depicts an exemplary embodiment of a computer system that may be used as client device 108, or a server device (not shown), etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 is shown in FIG. 5, depicting an exemplary embodiment of a block diagram of an exemplary computer system useful for implementing the present invention. Specifically, FIG. 5 illustrates an example computer 500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 is shown in FIG. 5. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 5.

The computer system 500 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 500.

Computer 500 may also include an input device such as, e.g., (but not limited to) a mouse or other pointing device such as a digitizer, and a keyboard or other data entry device (none of which are labeled).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to, a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 508 and/or the secondary memory 510 and/or removable storage units 514, also called computer program products. Such computer programs, when executed, may enable the computer system 500 to perform the features of the present invention as discussed herein. In particular, the computer programs, when executed, may enable the processor 504 to provide a method to resolve conflicts during data synchronization according to an exemplary embodiment of the present invention. Accordingly, such computer programs may represent controllers of the computer system 500.

In another exemplary embodiment, the invention may be directed to a computer program product comprising a computer readable medium having control logic (computer software) stored therein. The control logic, when executed by the processor 504, may cause the processor 504 to perform the functions of the invention as described herein. In another exemplary embodiment where the invention may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11 a, b, d and g, (including, e.g., but not limited to IEEE 802.11g-2003, etc.), etc.

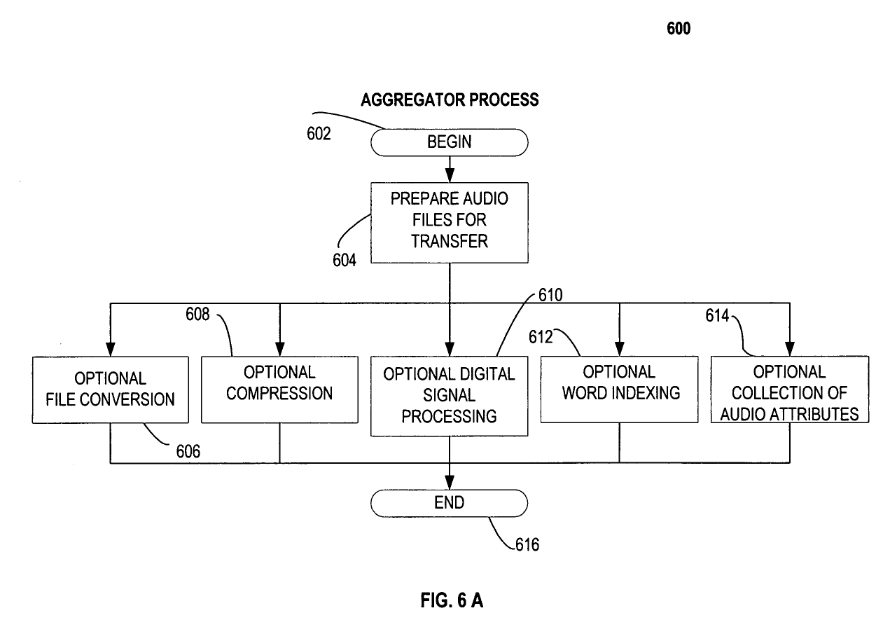

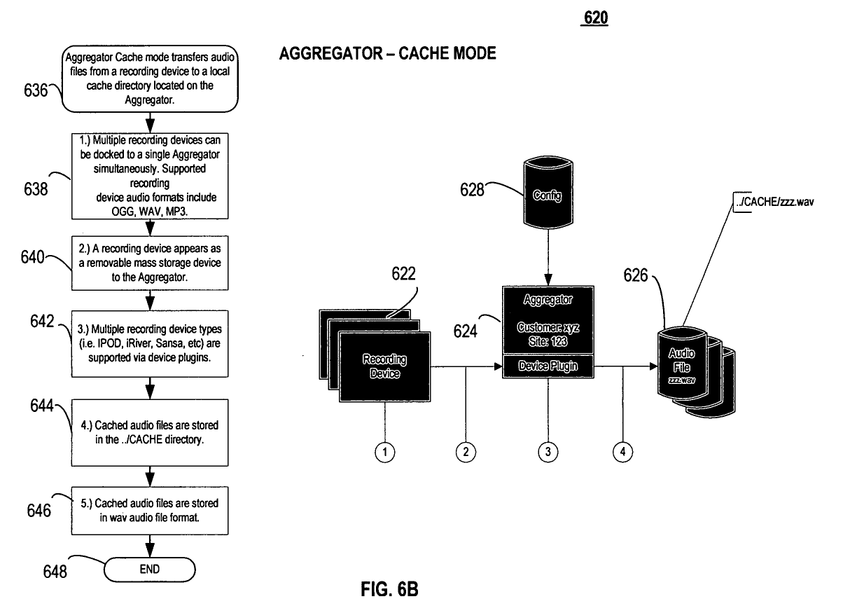

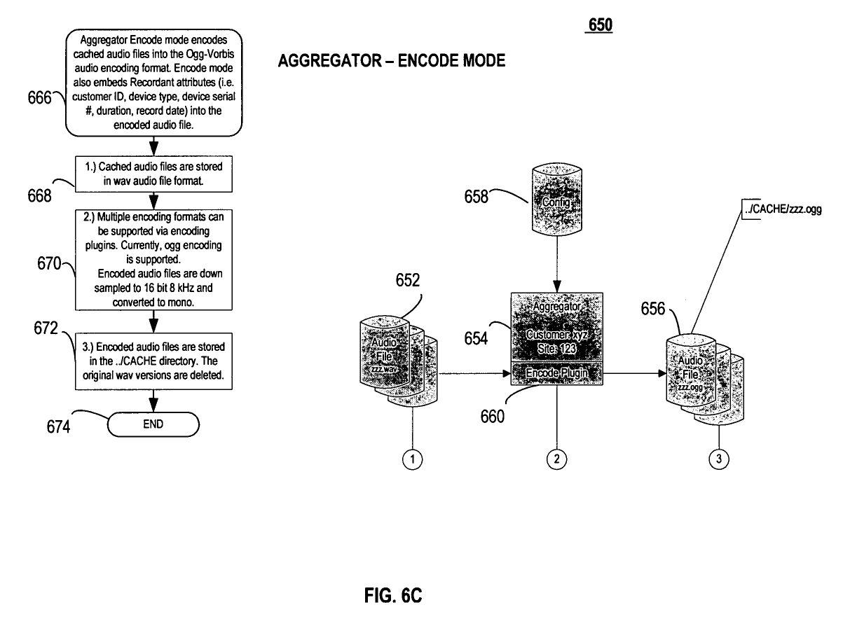

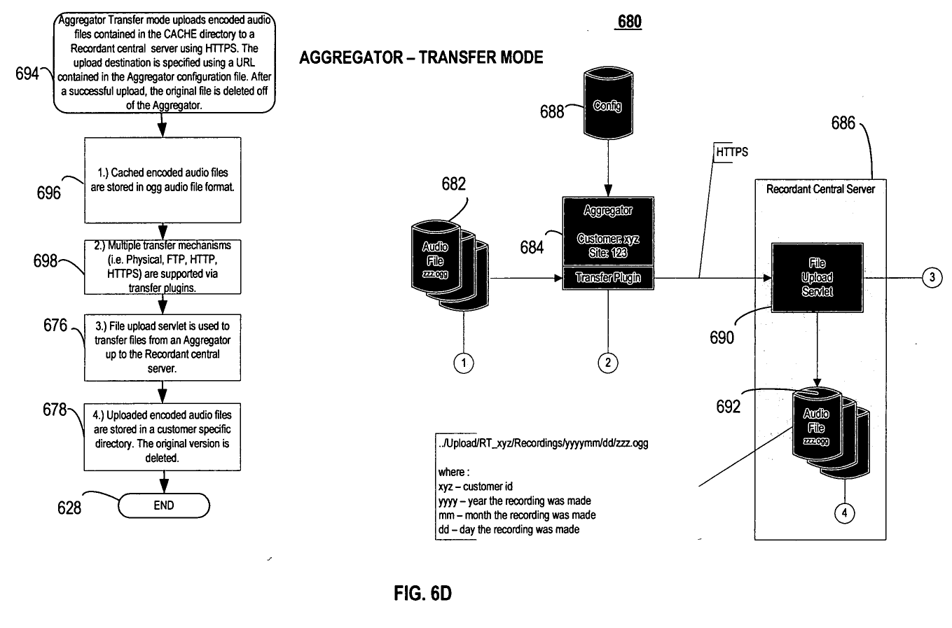

FIG. 6A depicts an exemplary aggregator software application flow diagram 600, which may prepare captured audio files from aggregation device 104 for transfer to a central server 112 for analysis and/or further processing, according to an exemplary embodiment of the present invention. The aggregator process, according to an exemplary embodiment, may handle the processing of transferring the recorded files from the recording devices (e.g., iPod, Zen, Dell, etc.) to a central server. The aggregator process may prepare the audio files to be transferred to the consolidator process. The aggregator process may perform the optional tasks of file conversion (compression), some digital signal processing, word indexing, and/or collection of audio attributes. The aggregator may also schedule file transfers for off-peak times. The aggregator may reside on the Single Board Computer (SBC) 104, in an exemplary embodiment.

Flow diagram 600, according to an exemplary embodiment may begin with 602 and may continue immediately with 604.

In 604, the aggregator process may prepare captured interaction digital audio files for transfer, in an exemplary embodiment. From 604, aggregator may perform any of 606-614, according to an exemplary embodiment.

In 606, an interaction may be converted from one format to another, in an exemplary embodiment. From 606, flow diagram may continue with 616 and may immediately end.

In 608, an interaction may be compressed to prepare the interaction file for transmission to server 112, in an exemplary embodiment. From 606, flow diagram may continue with 616 and may immediately end.

In 610, digital signal processing may be performed, in an exemplary embodiment, such as, e.g., filtering, noise reduction, etc. From 606, flow diagram may continue with 616 and may immediately end.

In 612, word indexing may be performed, in an exemplary embodiment. From 606, flow diagram may continue with 616 and may immediately end.

In 614, audio attributes may be collected, in an exemplary embodiment. From 606, flow diagram may continue with 616 and may immediately end.

FIG. 6B depicts an exemplary view 620 of an exemplary aggregator application software process in an exemplary cache mode, including an exemplary process flow diagram according to an exemplary embodiment of the present invention. An exemplary plurality of recording devices 102 622 are depicted transferring captured interactions to aggregator 624 via a device plugin. Aggregator 624 is shown receiving configuration data 628 and generating audio files 626 which may be stored in a cache directory.

The aggregator cache mode flow diagram 620 may begin with 636 and may transfer audio (and/or other captured content) files to a local cache directory, which may be located on aggregator 624. From 636 flow diagram 620 may begin with 638.

In 638, shown at reference numeral 1, multiple recording devices 102 622 may be docked to a single aggregator 624 simultaneously. In an exemplary embodiment, multiple device data formats may be supports such as, e.g., but not limited to, device audio formats such as, e.g., OGG, WAV, MP3, etc. From 638, flow diagram 620 may continue with 640.

In 640, shown at reference numeral 2, a recording device may appear as a removable mass storage device to the aggregator 624. From 640, flow diagram 620 may continue with 642.

In 642, shown at reference numeral 3, multiple recording device types may be supported via device plug-ins. In an exemplary embodiment, exemplary recording device types may include, e.g., but not limited to, IPOD, iRiver, Sansa, etc. From 642, flow diagram 620 may continue with 644.

In 644, shown at reference numeral 4, cached audio files may be stored in a directory. In an exemplary embodiment, the directory may include, e.g., but not limited to, a directory of path ../CACHE, etc. From 644, flow diagram 620 may continue with 646.

In 646, shown at reference numeral 5, cached audio files may be stored in an audio file format. In an exemplary embodiment, an exemplary audio file format may include, e.g., but not limited to, WAV audio file format, etc. From 646, flow diagram 620 may continue with 648, which may end immediately.

FIG. 6C depicts an exemplary view 650 of an exemplary aggregator application software in an exemplary encode mode, including an exemplary process flow diagram according to an exemplary embodiment of the present invention. An exemplary plurality of audio files 652 are depicted which may be encoded by aggregator 654 via an encode plugin 660. Aggregator 654 is shown receiving configuration data 658 and generating audio files 656 in an exemplary OGG, or other encoded format, which may be stored in a cache directory.

The aggregator encode mode flow diagram 650 may begin with 666 and may encode cached audio (and/or other captured content) files into another encoding format such as, e.g., but not limited to, an exemplary Ogg-Vorbis audio encoding format. An exemplary encode mode format may also embed exemplary attributes such as, e.g., but not limited to, a customer identifier (ID), a device type, device serial number, duration of the content, recording date, etc., into the encoded audio file, which may be stored in a local cache directory, which may be located on aggregator 654. From 666 flow diagram 650 may begin with 668.

In 668, shown at reference numeral 1, cached audio files 652 may be stored in a first audio format such as, e.g., but not limited to, an exemplary WAV audio file format. In another exemplary embodiment, multiple data formats may be supported. Exemplary audio formats may include, e.g., but not limited to, OGG, WAV, MP3, etc. From 668, flow diagram 650 may continue with 670.

In 670, shown at reference numeral 2, in an exemplary embodiment, multiple encoding formats may be supported by aggregator 654 via one or more exemplary encoding plugins 660. In an exemplary embodiment, OGG encoding may be supported. In another exemplary embodiment, other encoding plugins supporting other encoding formats may be used with aggregator 654. In an exemplary embodiment, encoded audio files may be down sampled to 16 bit 8 kHz and may be converted to mono, if captured in stereo or other higher fidelity modes. From 670, flow diagram 650 may continue with 672.

In 672, shown at reference numeral 3, encoded audio files may be stored in an exemplary directory. In an exemplary embodiment, the directory may include, e.g., but not limited to, a directory of path ../CACHE, etc. In an exemplary embodiment, after encoding and storage of the encoded data files, the original data files may be deleted. From 672, flow diagram 650 may continue with 674, which may end immediately.

FIG. 6D depicts an exemplary view 680 of an exemplary aggregator application software in an exemplary transfer mode, including an exemplary process flow diagram, according to an exemplary embodiment of the present invention. An exemplary plurality of encoded audio files 682 may be transferred via a transfer plugin of aggregator 684, which may receive configuration data from 688, and may be uploaded in a CACHE directory to an exemplary central or other server 686 using a secure protocol such as, e.g., but not limited to, HTTPS. In an exemplary embodiment, the upload destination may be specified using a universal resource locator (URL) which may be contained in the aggregator configuration file 688. Central server 686 may include a file upload servlet 690, for file transfer of captured interactions from aggregator 684 to the server 684. In an exemplary embodiment, uploaded encoded files 692 may be stored in a customer specific directory as shown.

The aggregator transfer mode flow diagram 680 may begin with 694 and may upload encoded audio (and/or other captured content) files, which may be contained in a local cache directory located on aggregator 684, to a central server using a secure protocol, such as, e.g., but not limited to, secure hypertext transfer protocol (HTTPS). In an exemplary embodiment, the upload destination may be specified by URL, which may appear in an exemplary configuration file 688. In an exemplary embodiment, once uploaded, the original copy of the file at the aggregator 684 may be deleted. From 694 flow diagram 680 may begin with 696.

In 696, shown at reference numeral 1, in an exemplary embodiment, cached encoded audio (and/or other content) files 682 may be stored in an exemplary OGG audio file format. In an exemplary embodiment, multiple device data formats may be supported such as, e.g., but not limited to, device audio formats such as, e.g., OGG, WAV, MP3, etc. From 696, flow diagram 680 may continue with 698.

In 698, shown at reference numeral 2, aggregator 684 may take encoded audio files 682, and multiple transfer mechanisms such as, e.g., but not limited to, physical, file transfer protocol (FTP), hypertext transfer protocol (HTTP), Secure HTTP (HTTPS), etc. may be supported via exemplary transfer plugins. From 698, flow diagram 680 may continue with 676.

In 676, shown at reference numeral 3, file upload servlet 690 may be used to transfer files from an aggregator up to an exemplary central server 686, according to an exemplary embodiment. From 676, flow diagram 680 may continue with 678.

In 678, shown at reference numeral 4, uploaded encoded exemplary audio files may be stored in a customer specific directory, according to an exemplary embodiment. In an exemplary embodiment, the directory may include, e.g., but not limited to, a directory of path ../Upload/RT_xyz/Recordings/yyyymm/dd/zzz.ogg, etc., where in an exemplary embodiment, xyz may be the customer id, yyyy may be a year the recording was made, mm may be the month of the recording, and dd may be the day of the recording. From 678, flow diagram 680 may continue with 628, which may end immediately.

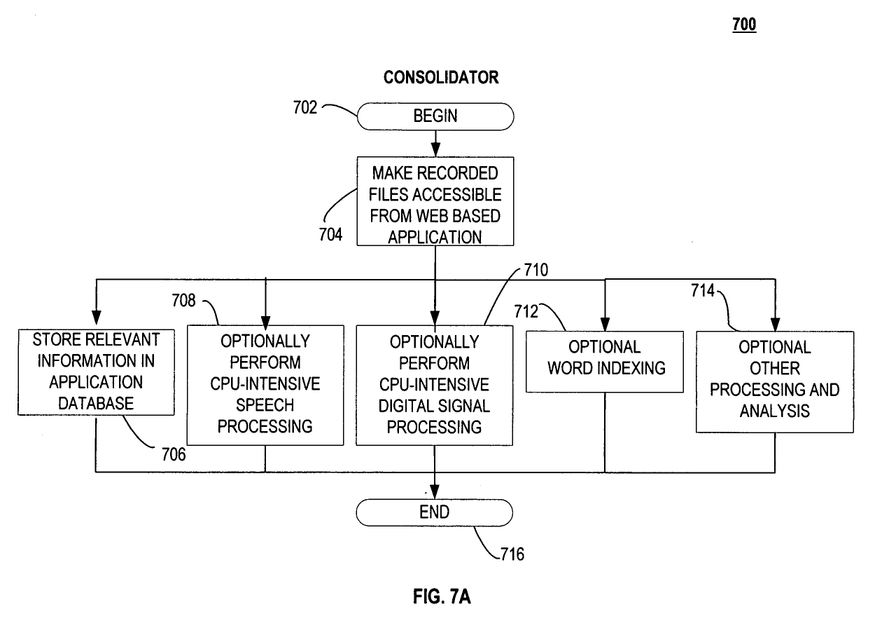

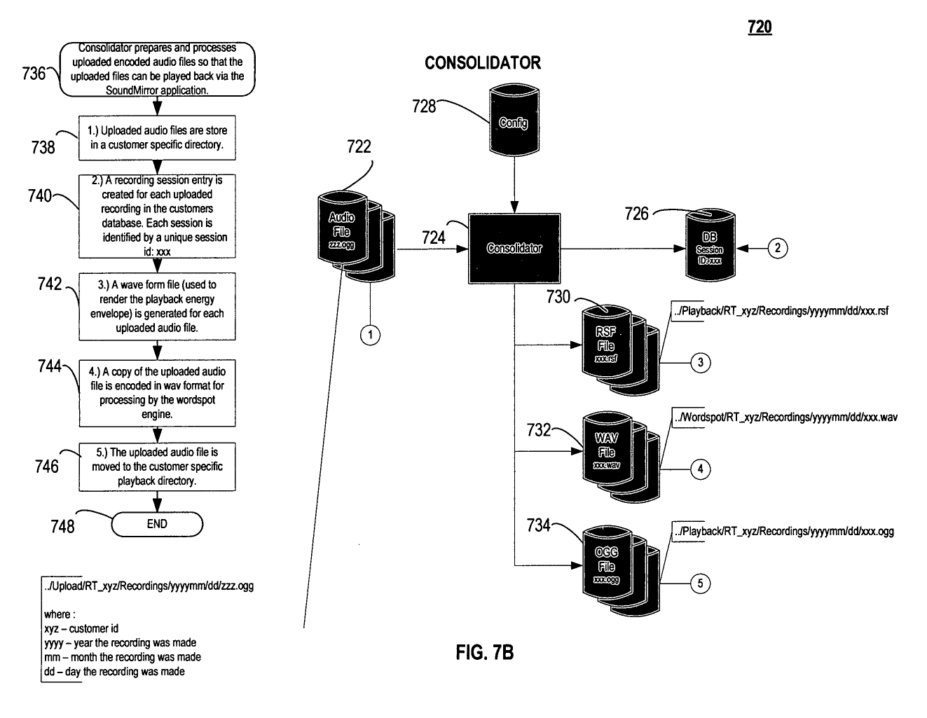

FIG. 7A depicts an exemplary consolidator application software flow diagram 700, which may make exemplary recorded interaction files accessible from, e.g., a web-based application portal, according to an exemplary embodiment of the present invention. The consolidator process, according to an exemplary embodiment of the present invention, may place the recorded files into a folder that may be accessible from the web based access, management, and playback portal application and may store relevant information in the application database, as discussed further below. The consolidator process, in an exemplary embodiment, may be a background procedure and may require no user intervention. The consolidator may also perform any CPU intensive speech or DSP processing, according to an exemplary embodiment of the present invention. The consolidator may reside on either the SBC 104 aggregator device, or back-end servers 112, according to an exemplary embodiment of the present invention. According to an exemplary embodiment, the consolidator may be an application executed as an application service provider (ASP) application.

Flow diagram 700, according to an exemplary embodiment may begin with 702 and may continue immediately with 704.

In 704, the consolidator process may make recorded captured interaction digital audio (and/or other content) files available for interactive user access, playback, annotation, assessment/scoring, and/or other analysis, storage or deletion, in an exemplary embodiment. From 704, consolidator may perform any of 706-714, according to an exemplary embodiment.

In 706, optionally, relevant information about a given interaction may be analyzed, captured and stored in an exemplary application database, in an exemplary embodiment. From 706, flow diagram may continue with 716 and may immediately end.

In 708, optionally, speech processing such as, e.g., but not limited to, voice recognition, speech recognition, speaker recognition, wordspotting, processor or central processing unit (CPU)-intensive speech processing, etc. of a given exemplary interaction may be performed on server 112, in an exemplary embodiment. From 706, flow diagram may continue with 716 and may immediately end.

In 710, optionally, digital signal processing may be performed, in an exemplary embodiment, such as, e.g., CPU-intensive processing, filtering, noise reduction, etc. From 706, flow diagram may continue with 716 and may immediately end.

In 712, optionally, exemplary word indexing, or other exemplary indexing of exemplary interaction data, may be performed, in an exemplary embodiment. From 706, flow diagram may continue with 716 and may immediately end.

In 714, optionally, other processing, or analysis of audio and other content attributes may be collected, and metadata may be captured and/or stored, in an exemplary embodiment. From 706, flow diagram may continue with 716 and may immediately end.

FIG. 7B depicts an exemplary view 720 of an exemplary flow diagram of an exemplary consolidator application software flow diagram, which may prepare and process uploaded encoded audio files, to allow playback, review assessment/scoring, and/or alerts, etc., according to an exemplary embodiment of the present invention. An exemplary plurality of exemplary encoded audio files 722 may be accessed by consolidator 724, which may receive configuration data from 728, may be create an exemplary recording session database (DB) record 726, may generate an exemplary playback energy envelope 730, may generate an exemplary encoded WAV or other appropriate input format to speech recognition processing such as, e.g., a wordspot engine, and/or may move the uploaded audio (and/or other content) file to an exemplary customer-specific playback directory. In an exemplary embodiment, uploaded encoded files 722 may have a customer specific upload directory name. In an exemplary embodiment, the customer specific directory may include, e.g., but not limited to, the directory of path ../Upload/RT_xyz/Recordings/yyyymm/dd/zzz.ogg, etc., where in an exemplary embodiment, xyz may be the customer id, yyyy may be a year the recording was made, mm may be the month of the recording, and dd may be the day of the recording.

The consolidator flow diagram 720 may begin with 736 and may perform exemplary preparation and processing functions on exemplary upload encoded audio (and/or other captured content) files, to enable user interactive access such as, e.g., but not limited to, playback, review, analysis, assessment/scoring, alerts, reports, etc., which may be contained in an upload directory of the central server 112, in an exemplary embodiment. From 736 flow diagram 720 may begin with 738.

In 738, shown at reference numeral 1, in an exemplary embodiment, uploaded encoded audio (and/or other content) files 722, which may be stored in an exemplary OGG audio file format, in a customer specific upload directory may be stored and/or accessed by consolidator 724. In an exemplary embodiment, multiple device data formats may be supported such as, e.g., but not limited to, device audio formats such as, e.g., OGG, WAV, MP3, etc. From 738, flow diagram 720 may continue with 740.

In 740, shown at reference numeral 2, consolidator 724 may use the encoded audio files 722, and using configuration records 728, may create a recording session entry record in the database 726, according to an exemplary embodiment, for each uploaded recording in a customer's directory. Each recording session may be identified by a unique recording session identifier, session ID:xxx, which may be stored in the database 726, according to an exemplary embodiment. From 740, flow diagram 720 may continue with 742.

In 742, shown at reference numeral 3, an exemplary wave form file 730 may be generated, which may be used to render an exemplary playback energy envelope, for each uploaded audio file 722. In an exemplary embodiment, the wave form file 730 which may be used to render the playback energy envelope may be stored in a customer specific directory, according to an exemplary embodiment. In an exemplary embodiment, the directory may include, e.g., but not limited to, a directory of path ../Playback/RT_xyz/Recordings/yyyymm/dd/xxx.rsf, etc., where in an exemplary embodiment, xyz may be the customer id, yyyy may be a year the recording was made, mm may be the month of the recording, and dd may be the day of the recording. From 742, flow diagram 720 may continue with 744.

In 744, shown at reference numeral 4, an exemplary copy of an exemplary uploaded encoded audio file 722 may be encoded in, e.g., but not limited to, an exemplary WAV format 732 appropriate as input for processing by an exemplary wordspot engine. In an exemplary embodiment, the encoded WAV format file 732 may be stored in a customer specific directory, according to an exemplary embodiment. In an exemplary embodiment, the directory may include, e.g., but not limited to, a directory of path ../Wordspot/RT_xyz/Recordings/yyyymm/dd/xxx.wav, etc., where in an exemplary embodiment, xyz may be the customer id, yyyy may be a year the recording was made, mm may be the month of the recording, and dd may be the day of the recording. From 744, flow diagram 720 may continue with 746.

In 746, shown at reference numeral 5, each of the exemplary uploaded audio files 722 may be moved to a customer specific playback directory for access by the user when using a browser based web application, according to an exemplary embodiment. In an exemplary embodiment, the directory may include, e.g., but not limited to, a directory of path ../Playback/RT_xyz/Recordings/yyyymm/dd/xxx.ogg, etc., where in an exemplary embodiment, xyz may be the customer id, yyyy may be a year the recording was made, mm may be the month of the recording, and dd may be the day of the recording. From 742, flow diagram 720 may continue with 744. From 746, flow diagram 720 may continue with 748, which may end immediately.

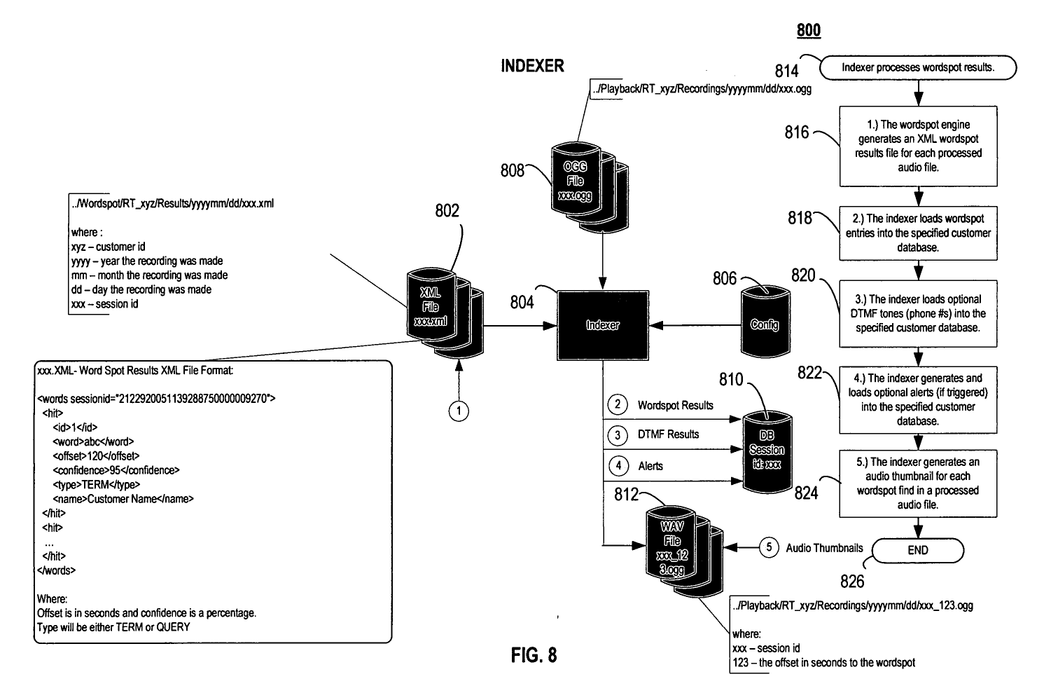

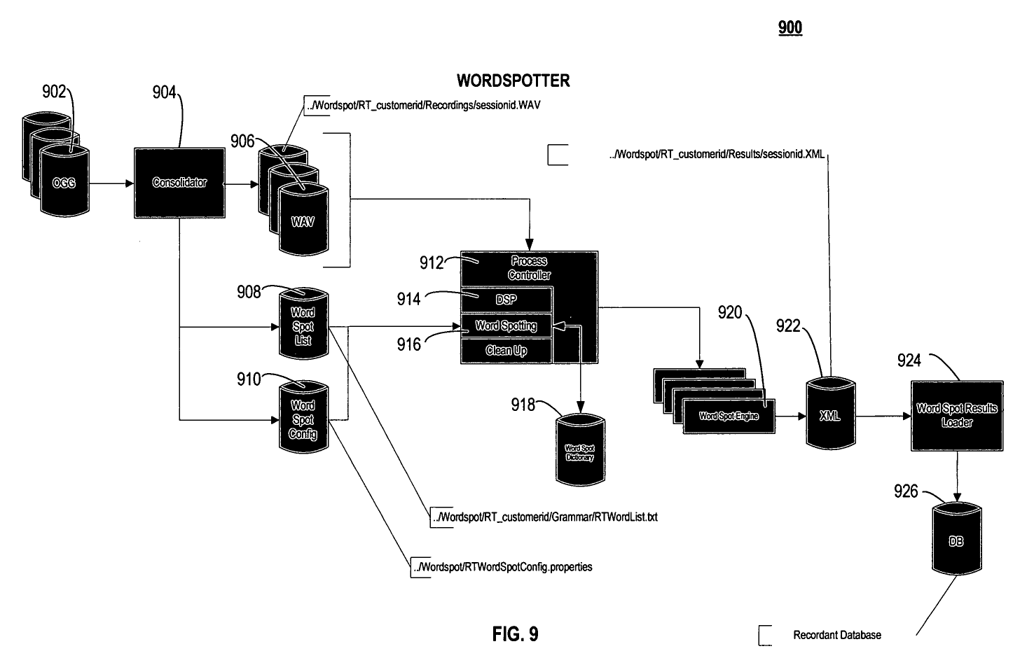

FIG. 8 depicts an exemplary view 800 of an exemplary indexer software application process flow diagram, which may process wordspot results, dual tone multiple frequency (DTMF) tones, and generate exemplary audio thumbnails, according to an exemplary embodiment of the present invention. An exemplary word spot results file 802, which may be in an extensible markup language (XML) format, may be processed by indexer 804, for each processed audio file 808, which may receive configuration data from 806, may be create an exemplary wordspot results, DTMF results, and alerts database (DB) records, for the session ID associated with the session of which the Wordspot results was obtained. In an exemplary embodiment, an exemplary WAV file xxx_{—}123.ogg audio thumbnail may be created in an exemplary directory, where the xxx is the session id, and the 123 is the offset in seconds to the wordspot. In an exemplary embodiment, an audio thumbnail™ may be an audio clip, which may be brief that has a time, in an exemplary embodiment, of approximately, about 10-20 seconds and may be about 15 seconds and may be centered on the offset to the wordspot. In an exemplary embodiment, the indexer 804 may take as input, the output of wordspot engine 920, discussed further below with reference to FIG. 9. In an exemplary embodiment, XML Wordspot XML files 802 may have a file format like the exemplary XML file format illustrated in the lower left corner of FIG. 8. In an exemplary embodiment, for every hit of the wordspotter of a desired term of a termlist, the following may be provided, an ID may be included in the file format, a word, a confidence rating, a term, and a customer name. In the original wordspot result file 802, the filename and directory may have a customer specific upload directory name. In an exemplary embodiment, the customer specific directory may include, e.g., but not limited to, the directory of path ../Wordspot/RT_xyz/Recordings/yyyymm/dd/xxx.xml, where in an exemplary embodiment, xyz may be the customer id, yyyy may be a year the recording was made, mm may be the month of the recording, and dd may be the day of the recording, and xxx may be the session ID.

The indexer flow diagram 820 may begin with 814, and the indexer may process wordspot results obtained from wordspot engine 920. The indexer 804 may use wordspot results 802 to, e.g., create records in the database 810 for accessing audio thumbnails 812 at the point of identified wordspot results 802. From 814, flow diagram 800 may begin with 816.

In 816, shown at reference numeral 1, in an exemplary embodiment, the wordspot engine may create an XML wordspot results file for each processed audio file as discussed in further detail with reference to FIG. 9, below. From 816, flow diagram 800 may continue with 818.

In 818, shown at reference numeral 2, the indexer 804 may load wordspot entries in a specified customer database record 810 associated with the session ID from which the wordspot results file 802 was created, and may use the encoded audio files 808, and may use configuration records 806, if needed. The wordspot results record may be created for the recording session entry record in the database 810, according to an exemplary embodiment, for each uploaded recording in a customer's directory. Each recording session may be identified by a unique recording session identifier (ID), session ID:xxx, which may be stored in the database 810, according to an exemplary embodiment. From 818, flow diagram 800 may continue with 820.

In 820, shown at reference numeral 3, the indexer 804 may load optional dual tone multiple frequency (DTMF) tones (i.e., phone numbers) into a specified customer database 810, in an exemplary embodiment. From 820, flow diagram 800 may continue with 822.

In 822, shown at reference numeral 4, the indexer 804, in an exemplary embodiment, may generate and/or load optional alerts (if triggered by a wordspotting identified occurrence of a term from a term list) into a record of the database 810 associated with the session ID matching the wordspot results file 802 which triggered the alert. From 822, flow diagram 800 may continue with 824.

In 824, shown at reference numeral 5, the indexer 804, in an exemplary embodiment may generate an audio thumbnail 812 for each wordspot find in a processed audio file. In an exemplary embodiment, the audio thumbnail 812 may be given a name ../Playback/RT_xyz/Recordings/yyyymm/dd/xxx_{—}123.ogg, where in an exemplary embodiment, xyz may be the customer id, yyyy may be a year the recording was made, mm may be the month of the recording, and dd may be the day of the recording, and where xxx is the session id and 123 is the offset in seconds to the wordspot. From 824, flow diagram 800 may continue with 826, which may end immediately, in an exemplary embodiment.

FIG. 9 depicts an exemplary view 900 of an exemplary word spotting process flow diagram, which may be used to perform digital signal processing, word spotting from a word spot dictionary, clean up, executing wordspotting based on wordspot lists, according to an exemplary embodiment of the present invention. In an exemplary embodiment of the present invention, encoded audio files 902 may be encoded in an exemplary OGG file format, in an exemplary embodiment, and may be converted by consolidator 904 into WAV file format files, which may be fed into a process controller 912, which may perform digital signal processing (DSP) 912, clean up, word spotting 916 using word spot dictionary 918, and may control word spot engine 920 which may generate XML files 922, which may be entitled ../Wordspot/RT_customerid/Results/sessionid.XML. Consolidator 904, in an exemplary embodiment, may generate word sport list 908, which may be named ../Wordspot/RT_customerid/Grammar/RTWordList.txt. Consolidator 904, in an exemplary embodiment, may generate word sport configuration 910, which may be named ../Wordspot/RT_WordSpotConfig.properties. XML result files 922 may be fed a word spot results loader 924, which may populate a database record of database 926.

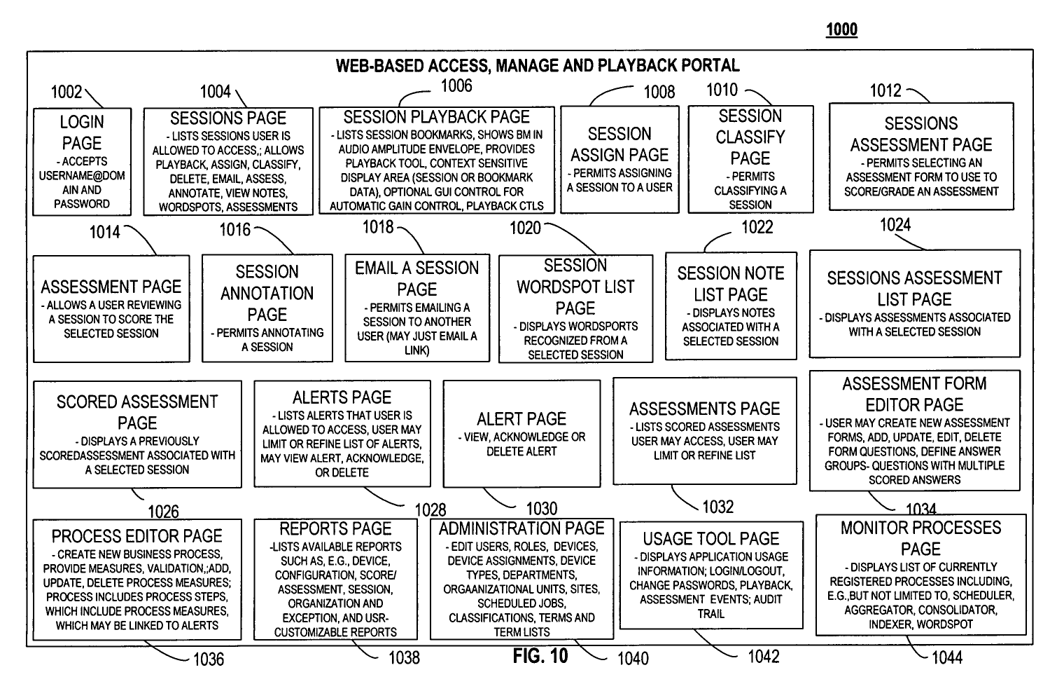

FIG. 10 depicts an exemplary view 1000 of an exemplary web-based access, management, and playback portal including, in an exemplary embodiment, various graphical user interface (GUI) application pages. In an exemplary embodiment, exemplary GUI application pages may include, e.g., but not limited to, an exemplary login page 1002, a sessions page 1004, a session playback page 1006, a session assign page 1008, a session classify page 1010, a sessions assessment page 1012, an assessment page 1014, a session annotation page 1016, an email a session page 1018, a session wordspot list page 1020, a session note list page 1022, a sessions assessment list page 1024, a scored assessment page 1026, an alerts page 1028, an alert page 1030, an assessments page 1032, an assessment form editor page 1034, a process editor page 1036, a reports page 1038, an administration page 1040, a usage tool page 1042, and a monitor processes page 1044, according to an exemplary embodiment of the present invention. The web application, according to an exemplary embodiment, may present an authorized user with certain functions to, e.g., but not limited to, listen, assess and report on recorded captured interactions stored by the consolidator. In addition, according to an exemplary embodiment, the web application can perform backend analytics and may send notifications/alerts via email based on business rules. The web based portal application may, according to an exemplary embodiment, be completely web based and may be accessible without having to deploy desktop applications to the users. In another exemplary embodiment, the portal may be an interactive user application or applet, and need not be web-based.

An exemplary login page 1002 in an exemplary embodiment may include a Login page which may be used by the user to login into an exemplary session access, management and playback portal application such as, e.g., but not limited to the SoundMirror™ application available from Recordant, Inc. of Atlanta, Ga., U.S.A. The user login name may determine which customer the user belongs to, by reviewing the domain name of the user, in an exemplary embodiment. The user login name may also be used to determine what menu options the user has access to, which application permissions are available to the user and what data the user may be allowed to view as customized by the given customer in administrative user management, role and organizational unit settings, in an exemplary embodiment. An exemplary login screen may provide an application user validation and logon functionality. According to an exemplary embodiment, various functions may be provided at login including, e.g., but not limited to the following: 1) The username and password may be validated against information stored in the application database. 2) The password value may be stored as an encrypted string. 3) The encrypted password string may use a one way encryption technique so that the passwords can't be reverse engineered from the system. 4) The user name and password may determine what functions the user may have access to once they have successfully logged in. 5) The database may store password history to force users to constantly choose new passwords. 6) Password changes can be forced based on a specified number of days since the user last changed their password. 7) The system may be track the number of invalid attempts and may lock an account after a predefined number of failed login attempts. 8) Once a user has successfully gained access to the system the user's ID may be used for audit purposes as they navigate through the system. 9) The system can deactivate a user's account without having to have it removed from the system.

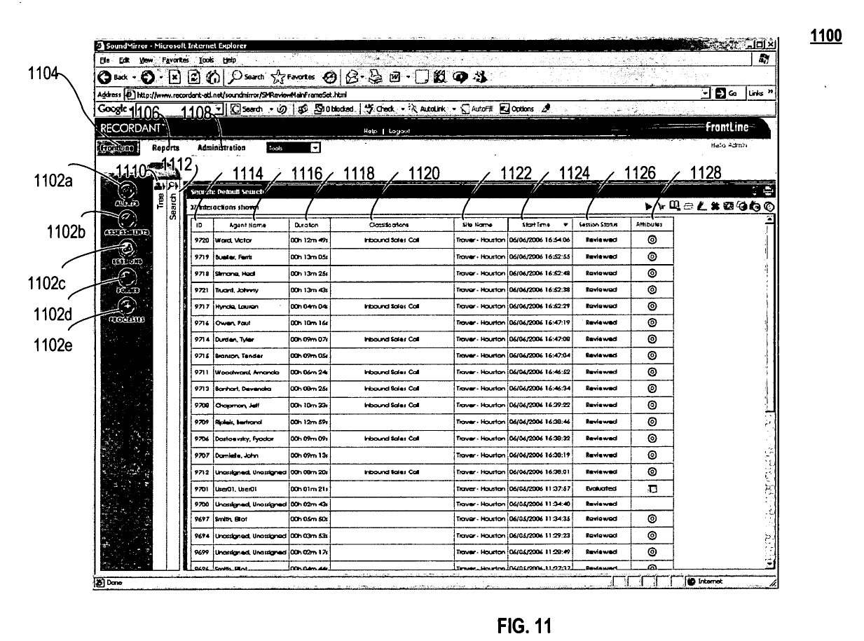

A sessions page 1004 in an exemplary embodiment may include a Sessions page, which may list the sessions that a logged in user may be allowed to see, as illustrated below with reference to FIG. 11. A default session list criteria can be specified when the session list is displayed, in an exemplary embodiment. The user can specify additional session selection criteria in order to limit or refine the list of displayed sessions, in an exemplary embodiment. The operations that can be performed on a session may include, in an exemplary embodiment: playback a session, assign a session, classify a session, delete a session, email a session, assess a session, annotate a session, view session notes, view session word spots and/or view session assessments, etc., in an exemplary embodiment. An exemplary sessions page may include search functions (providing a search interface to query recordings by, e.g., site, users, status, date range, a drop list for quick searches; playback, which may launch the playback tool for a selected recording (“session”); assessment, providing a menu link to an assessment form; status, a visual indicator which may provide current status of each of the sessions in the system.

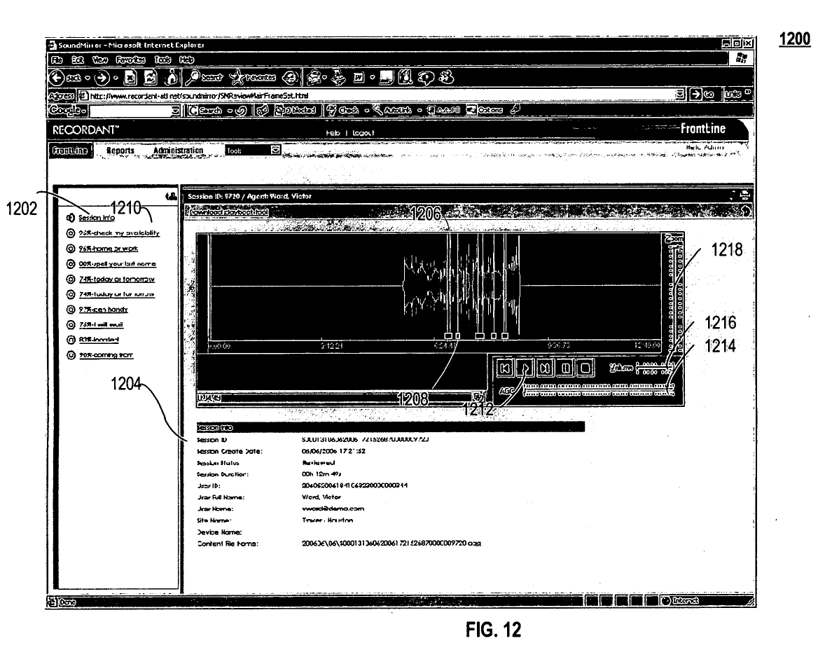

A session playback page 1006 in an exemplary embodiment may include a Session playback page which may be displayed when the user selects a session to playback. The session playback page, as illustrated below with reference to FIG. 12, may include three sections, in an exemplary embodiment, which may include, e.g., but not limited to: a session bookmark list, a playback tool and a context sensitive display area (which may be located below the playback tool), in an exemplary embodiment. The session bookmark list may display assessment, note, wordspot and DTMF type bookmarks, as illustrated below with reference to FIG. 12, in an exemplary embodiment. When a user clicks on a bookmark, bookmark specific (context sensitive) information may be displayed in the context sensitive display area, in an exemplary embodiment.

A session assign page 1008 in an exemplary embodiment may include a Session assign page which may be used to assign a session to a user. In an exemplary embodiment, the session assign page 1008 may be used to assign “unassigned” sessions to a specific user.

A session classify page 1010 in an exemplary embodiment may include a Session classification page, which may be used to classify a session. The user can create custom classifications that may be specific to a particular business, in an exemplary embodiment. Sessions can be classified, in an exemplary embodiment, manually (using a session classification page screen) or automatically (using, e.g., an indexer process, see description above with reference to FIG. 8).

A sessions assessment page 1012 in an exemplary embodiment may include a Session assessment page, which may be configured to assess a session. Specifically, in an exemplary embodiment, this page may allow a user to select an assessment form that may be used to score or grade a selected session.

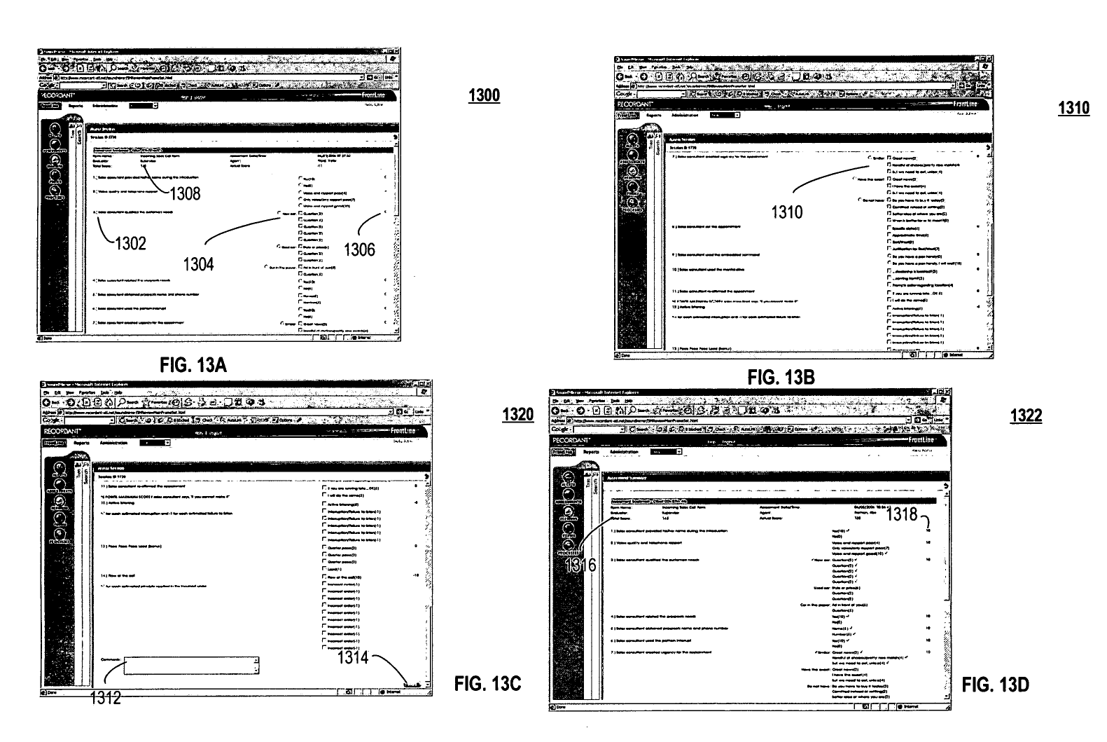

An assessment page 1014 in an exemplary embodiment may allow a user to score a selected session using a selected assessment form. An exemplary assessment page 1014 and continuation screens are described further below with reference to FIGS. 13A, 13B and 13C, below.

A session annotation page 1016 in an exemplary embodiment may include functionality to annotate a session. Zero, one, or more annotations or notes made be associated with a selected session, in an exemplary embodiment. Notes may be free format comments regarding a selected session, according to an exemplary embodiment.

An email a session page 1018 in an exemplary embodiment may be used to email a selected session to a specified user. The actual session need not be emailed to the specified user, in one exemplary embodiment. Instead, a link back to the session may be emailed to the specified user, in one exemplary embodiment.

A session wordspot list page 1020 in an exemplary embodiment may display word spots which may be associated with the selected session.

A session note list page 1022 in an exemplary embodiment may display notes associated with the selected session.

A sessions assessment list page 1024 in an exemplary embodiment may display the assessments associated with a selected session.

A scored assessment page 1026 in an exemplary embodiment may display a previously scored assessment associated with the selected session. An exemplary view of a scored assessment page 1026 is described further below with reference to FIG. 13D, below.

An alerts page 1028 in an exemplary embodiment may list alerts that the user may be allowed to see based on a privilege level associated with an associated role of the user. Default alert list criteria can be specified when the alert list is displayed, in an exemplary embodiment. The user can specify additional alert selection criteria in order to limit or refine the list of displayed alerts, in an exemplary embodiment. Exemplary operations that can be performed on an alert may include: view an alert, acknowledge an alert, delete an alert, etc., in an exemplary embodiment. An exemplary alerts page is described further below with reference to FIG. 14A.

An alert page 1030 in an exemplary embodiment may display the contents of a selected alert. The alert may provide the ability to playback the associated session or view the associated assessment, in an exemplary embodiment. An exemplary alert page is described further below with reference to FIG. 14B below.

An assessments page 1032 in an exemplary embodiment may list scored assessments that the user may be allowed to see. Default assessment list criteria may be specified when the assessment list is displayed, in an exemplary embodiment. The user can specify additional assessment selection criteria in order to limit or refine a list of displayed assessments, in an exemplary embodiment. The operations that can be performed on an assessment, in an exemplary embodiment, may include: viewing an assessment, annotating an assessment, viewing assessment notes and deleting an assessment, in an exemplary embodiment.

An assessment form editor page 1034 in an exemplary embodiment may be used to create new assessment forms, display questions associated with a selected form, and allow the user to add, update and delete form questions. In an exemplary embodiment, a page may be used to edit a selected question. The page may also allow the user to add, update and delete answer groups, in an exemplary embodiment. Answer groups may be used to define a question that may have multiple answers or responses and where each answer may have a specific score, in an exemplary embodiment. The page may display a question with a yes/no answer group, etc., in an exemplary embodiment.

A process editor page 1036 in an exemplary embodiment may be used to create new processes. A process can be any business process that may need to be measured or validated in an exemplary embodiment. Processes may be defined by a customer in an exemplary embodiment. The process editor page may display the measurements associated with a selected process, in an exemplary embodiment. The page may also allow the user to add, update or deleted selected process measures, in an exemplary embodiment. The page may be used to add a new process measurement to the selected process. The page may be used to specify the process measurement details for a new/existing process measurement, in an exemplary embodiment. An exemplary embodiment of process creation including creating a process, process steps, measures and measure details are described further below with reference to FIG. 15.

A reports page 1038 in an exemplary embodiment may provide access to a all available application reports. Reports may be classified as: configuration reports, device reports, score/assessment reports, session reports, organization reports and exception reports, according to an exemplary embodiment. In an exemplary embodiment, the following reports may be provided, including, but not limited to, a department report, a roles report, a sites report, a user report, a user contact report, a recording device report, a device assignment report, a device type report, a score report selection criteria page (e.g., may be used to specify score report selection criteria), a session report selection criteria page (e.g., may be used to specify session report selection criteria), an unassigned session report (e.g., flagging recording sessions captured which have not been associated with a user), an organizational unit report, an organizational unit by user report, an unassigned users report (e.g., may be used to assign a user to an organizational unit), and an exception report selection criteria page (e.g., may be used to specify exception report selection criteria).

An administration page 1040 in an exemplary embodiment may provide access to exemplary application administrative functions which may include: editing users, editing roles, editing devices, editing device assignments, editing device types, editing departments/sites/organizational units, editing scheduled jobs, editing classifications, editing terms and editing term lists, in an exemplary embodiment.

An Edit users list may, in an exemplary embodiment, display the list of application users. The page may provide, in an exemplary embodiment, the ability to add, update, delete and reset user passwords.

An Edit users page, in an exemplary embodiment, may provide the ability to edit general user information. The Edit users page, in an exemplary embodiment, may provide the ability to edit detailed user information. The Edit users page, in an exemplary embodiment, may provide the ability to edit user organizational assignments. The Edit users page, in an exemplary embodiment, may provide the ability to edit user device assignments.

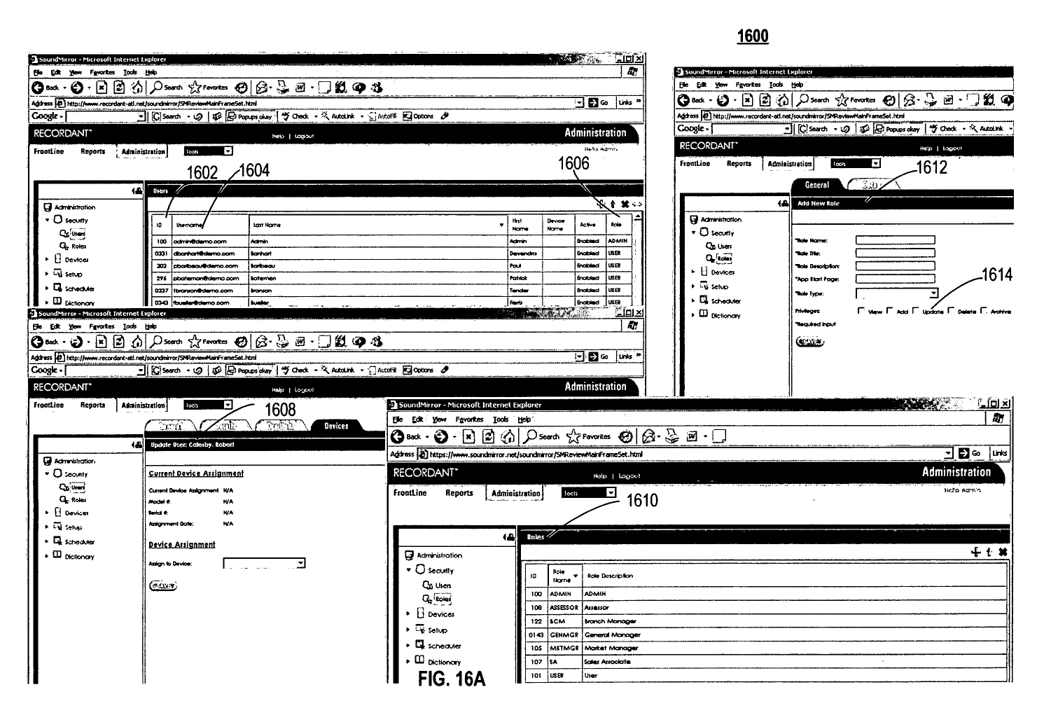

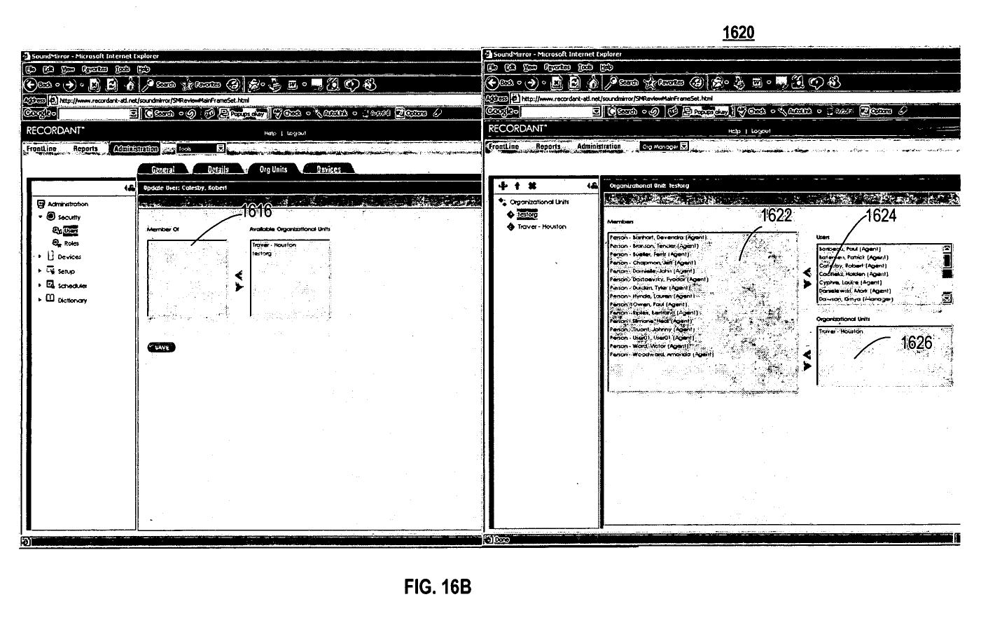

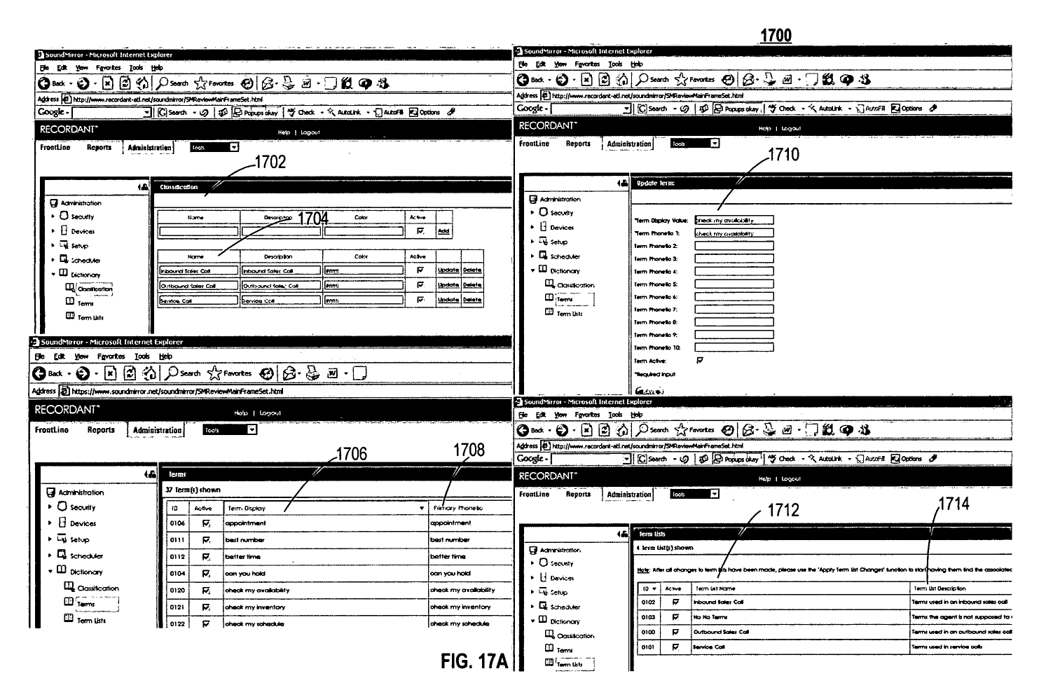

The Edit roles list, in an exemplary embodiment, may display the list of application roles. This page may provide the ability to add, update and delete roles, in an exemplary embodiment. See the discussion below with reference to FIG. 16A below regarding adding and updating user roles.

The Edit roles page, in an exemplary embodiment, may provide the ability to edit general role information including role permissions, see discussion of upper right corner of FIG. 16A, below. In an exemplary embodiment, the Edit roles page may provide the ability to edit detailed role information including available menu options.

The Edit device types page, in an exemplary embodiment, may provide the ability to add, update and delete recording device type information.

The Edit devices page, in an exemplary embodiment, may provide the ability to add, update and delete recording device information.

The Edit device assignments page, in an exemplary embodiment, may provide the ability to add, update and delete recording device assignment information, i.e., which device may be assigned to which user.

The Edit departments page, in an exemplary embodiment, may provide the ability to add, update and delete department information.

The Edit sites page, in an exemplary embodiment, may provide the ability to add, update and delete site information.

The Scheduled jobs page, in an exemplary embodiment, may display the current scheduled jobs, for managing scheduled jobs. Scheduled jobs, in an exemplary embodiment, may include: an aggregator job, a consolidator job and an indexer job. In an exemplary embodiment, multiple instances of these processes may be executed simultaneously and may be registered to a task registration process manager. In an exemplary embodiment, these processes may be executed on a periodic or aperiodic basis to check particular directories for files to be processed, in an exemplary polling based system. In another exemplary embodiment, the system may be event driven and occurrence of a particular thing may trigger a job to execute processing of a file.

The Edit classifications page may provide the ability to add, update and delete session classification information. See the description below with reference to FIG. 17A for further information.

The Term list page may display the current terms, in an exemplary embodiment. The terms list page also, in an exemplary embodiment, may provide the ability to add, update or deleted terms. See the discussion with reference to FIG. 17A for further information.

The Edit term page may provide the ability to edit the selected term. Each term can have one or more associated phonetic spellings, in an exemplary embodiment. See the discussion below with reference to FIG. 17A.

The Term list page may display the current term lists. This page, in an exemplary embodiment, may also provide the ability to add, update or deleted term list. A term list, in an exemplary embodiment, may be a collection of one or more terms that may represent a business process. Terms lists, in an exemplary embodiment, can be classified. See the discussion below with reference to FIG. 17A.

The Edit Term list page, in an exemplary embodiment, may provide the ability edit the selected term list. See the discussion below with reference to FIG. 17B.

The Organization unit editor, in an exemplary embodiment, may provide the ability add, update or delete organizational units. Organizational units, in an exemplary embodiment, may be used to group users and other organizational units. An organizational unit, in an exemplary embodiment, can contain one or more uses and or one or more organizational units. A user or organizational unit, in an exemplary embodiment, can belong to one or more organizational units. See the discussion below with reference to FIG. 16B.

The Edit organizational unit page, in an exemplary embodiment, may provide the ability to edit an organizational unit. The users and organizational units, in an exemplary embodiment, can be added or removed from the selected organizational unit. See the discussion below with reference to FIG. 16B.

A usage tool page 1042 in an exemplary embodiment may display application usage information, which may include login and logout events, change password events, playback events and assessment events, in an exemplary embodiment.

A monitor processes page 1044 in an exemplary embodiment may display the list of currently registered processes including, e.g., but not limited to: scheduler, aggregator and consolidator processes, according to an exemplary embodiment.

The following table represents exemplary technology standards that may be used to implement the processes used in the exemplary embodiments of the present invention:

| Technology | Description |
|---|---|
| Apache Tomcat | Web server and servlet engine, may be used to |
| | provide basic web publishing services. |
| SQLServer2000 | May be used to persist all application data. |
| | All user specific information may be stored |
| | in the database as well. |
| XSLT | Dynamic HTML rendering engine (uses servlets, XML |
| | and XSL stylesheets), may be used to render |
| | dynamically generated HTML pages and to provide |
| | support for internationalization requirements. |
| C++ | Programming language, may be used to implement |
| | aggregator and consolidator software. |
| Java | Programming language, may be used to implement |
| | back end business services and web services. |

In an exemplary embodiment, other pages may also be including, such as, e.g., but not limited to, a session time out page. An exemplary session timeout page may be displayed when a user session times out. The user may be given the ability to re-log back into the application from this page, in an exemplary embodiment.

FIG. 11 depicts an exemplary view 1100 of an exemplary graphical user interface (GUI) screenshot of an exemplary sessions page 1004, which may indicate a list of exemplary recorded interactions accessible, referred to as sessions, for further analysis and/or playback, assign a session, classify a session, delete a session, assess a session, annotate a session, view notes, view wordspots, view assessments, according to an exemplary embodiment of the present invention. The GUI may include, in an exemplary embodiment, a Frontline tab 1104 shown, a reports tab 1106, and an administration tab 1108, various buttons including, e.g., but not limited to, alerts 1102a, assessments 1102b, sessions 1102c, forms 1102d, and processes 1102e, expandable tree window 1110, and search window 1112. The complete GUI may be skinned with a logo or custom image of a customer, in an exemplary embodiment. As shown, the default search may display a unique session id 1114 (the last four digits of the session ID), agent name 1116 (agent name associated with the recording device), duration 1118 (the length of the session), classifications 1120 (determined by analysis of wordspotting and occurrence of sufficient terms of a term list that gets classified as a particular type of call, e.g., inbound sales call, outbound sales call, customer service inquiry, etc.), site name 1122 (based on the location or organization unit associated with the user), start time 1124 (a time stamp of the beginning of the recording), session status 1126 (indicating whether a session is ready for review, has been reviewed, evaluated, etc.), and/or attributes 1128 (notes, assessments, wordspots, indicating if there is an annotation, assessment, or wordspot completed and associated with the session), in an exemplary embodiment.

FIG. 12 depicts an exemplary view 1200 of an exemplary screen shot of an exemplary playback screen graphical user interface (GUI), which may allow playback of a session 1202 indicating an energy envelope 1206 (where amplitude may indicate the volume of the speaker voice and horizontally may be a time indication), which may indicate various exemplary bookmarks 1208 (which may include audio thumbnails for a given wordspot) for wordspot results 1210 of a selected session 1202, playback control buttons 1212 (e.g., but not limited to, for play, pause, reverse, forward, skip to end, skip to beginning, stop, etc.), zoom 1218, volume 1216, and automatic gain control 1214 (by which a user may drag the slider arm to bring the further away, lower volume person up in volume, so as to “bring them closer”, allowing equalizing of the two speaker, using the human user to select a desired sound level), context sensitive metadata 1204 (which may provide data about the session initially, then if a wordspot bookmark, annotation or assessment is selected, may switch to indicating metadata about the bookmark, etc.), according to an exemplary embodiment of the present invention. In an exemplary embodiment, bookmarks may be color coded such as, e.g., but not limited to, yellow may be used to represent bookmarks, red may be used for annotations, blue for assessments, white for DTMF type bookmarks.

FIGS. 13A, 13B, and 13C depict several exemplary views 1300, 1310, and 1320, respectively of exemplary screenshots of an exemplary assessment page for assessing a captured interaction, which may include multi-part questions 1302 and answers 1304, 1310 comment fields 1312, scoring 1306, total scores 1308, and save button 1314 according to an exemplary embodiment of the present invention.

FIG. 13D depicts an exemplary view of an exemplary screen shot of an exemplary completed assessment 1322, including a total score 1316, and individual question scores 1318, according to an exemplary embodiment of the present invention.

FIG. 14A depicts an exemplary view 1400 of an exemplary alerts page, which may list alerts including, in an exemplary embodiment, an urgency level such as, e.g., advisory, process 1404, process step 1406, agent name 1406, creation date of the alert 1406, the type 1408 of alert such as, e.g., wordspot exception, title 1410, which in an exemplary embodiment may include a brief summary of the alert. Alerts may be triggered as illustrated in FIG. 14B, below, based on identification of matched terms 1412 from word-spotting results of particular terms on an exemplary term list 1414, according to an exemplary embodiment of the present invention.

FIG. 14B depicts an exemplary view 1410 of an exemplary view alert page including details about a given alert being viewed, including an exemplary term list 1414 for triggering the exemplary alert, and a matched term list 1412 identified by the wordspotting engine triggering the alert, according to an exemplary embodiment of the present invention.

FIG. 15 depicts an exemplary view 1500 of exemplary screen shot views of an exemplary business process automation system including an exemplary process 1502 (of an exemplary inbound sales call, and additional processes may be added by the + icon), an exemplary process step 1504 (of a customer contact process step, and additional process steps may be added by the + icon), and exemplary measures 1506 (+ sign may be used to add measures), as part of the process step 1504 allowing adding a measure 1508 (including exemplary types of measures which may be added including, e.g., but not limited to, assessment measures, triggering off of assessment scores, and wordspot measures, triggering off of wordspot results) to trigger an alert upon satisfaction of exemplary criteria, and updating measures 1510 including, e.g., generating an exemplary alert based upon wordspot results of less than a user selected threshold level of terms being found from a termlist, generating an exemplary alert based upon wordspot results of between a user selected range of identified terms being found from a termlist, generating an exemplary alert based upon wordspot results that exceed a user selected threshold level of terms being found from a termlist, etc., according to an exemplary embodiment of the present invention.

FIG. 16A depicts an exemplary view 1600 of exemplary screen shot views of an exemplary administration system which may include for security, user and role management, and for an exemplary user management system, indicating for a user, a device ID 1602 assigned to the user, a username 1604 for the user, a last name of the user, a first name, a device name, an active status (whether enabled or not), a role 1606. In an exemplary embodiment, a user may be assigned a device 1608, a list of roles 1610 may be listed and using a + icon, additional roles may be added. New role types may be added 1612, in an exemplary embodiment, each role of which may include certain user access security privileges 1614 that may be assigned in administration mode. User access privileges, according to an exemplary embodiment of the present invention, may include the ability to view, add, update, delete, and/or archive, etc.

FIG. 16B depicts an exemplary view of exemplary screen shot views 1602 of an exemplary administrative user management system by which a user may be assigned to an organizations unit 1616, or member groups 1622 of selected users 1624 may be assigned at once to an organizational unit 1626, according to exemplary embodiments of the present invention.

FIG. 17A depicts an exemplary view 1700 of exemplary screen shot views of an exemplary classification system 1702 (where a new classification may be added, named, a description may be added, a color provided, an active status, an existing classification 1704 may be updated or deleted), terms 1706 may be setup, terms may be associated with a primary phonetic 1708, or additional phonetics may be associated 1710, as well as term lists may be managed including viewing a term list name 1712 for each term list identifier, active status level, and term list descriptions 1714 may be provided for the term list, according to an exemplary embodiment of the present invention.

FIG. 17B depicts an exemplary view 1720 of exemplary screen shot view of an exemplary term list update system, allowing selecting terms 1722 from available terms 1724, and setting threshold levels of term that must be matched in order to classify a session as a particular classification, according to an exemplary embodiment of the present invention.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A customer interaction collection and analysis system comprising:
an ambulatory capture device adapted to capture a face-to-face interaction between two parties; and
an analysis system, coupled to said capture device, adapted to receive and analyze said interaction.

2. The system according to claim 1, further comprising a collection device adapted to receive said interaction.

3. The system according to claim 1, wherein said capture device comprises at least one of:
a recording device;
a digital device;
a wired device;
a wireless device;
a microphone;
a fixed microphone;
a portable microphone;
a headset capture device;
a device that is worn by a user;
a device including a radio transmitter;
a video camera;
an audio capture device;
a video capture device;
a portable device;
an embedded device;
a computing device;
a communications device;
a personal digital assistant (PDA);
a handheld device;
a pocket PC device;
a synchronized device;
a witnessed interaction subsystem;
a telephony recording device;
an audio recording device;
a video recording device;
a telephony device;
a lapel microphone device;
a wireless telephony device;
a wireless LAN device;
a wiretap;
a device embedded in clothing;
a concealed device;
a point of sale (POS) device;
a digital audio device;
a digital video device; and/or
an analog device.

4. The system according to claim 1, wherein said analysis system comprises at least one of:
a customer relationship management (CRM) system;
a sales automation system;
means for analyzing customer visits;
a human resource management system;
an employee scheduling system; and/or
a workforce management system.

5. The system according to claim 1, wherein said at least one interaction further comprises at least one of:
data;
audio;
video;
a recording;
a file;
a stream;
a video stream;
an audio stream;
a media stream;
compressed format data;
uncompressed format data;
digital data;
sampled audio;
captured video;
digitized analog data;
data compressed at least compression format including at least one of:
a WAV format,
an MP3 format,
an OGG format,
an MPEG format,
an AVI format, and/or
another compression format;
data uncompressed in a format including at least one of:
pulse code modulated (PCM), and/or
another uncompressed format;
streamed data;
transferred data;
file transfer data including at least one of:
file transfer protocol (FTP),
hypertext transfer protocol (HTTP),
secure HTTP (HTTPS),
secure copy protocol (SCP),
trivial FTP (TFTP),
kermit, and/or
xmodem;
copied data;
a screen capture;
a screen capture synchronized with said interaction; and/or
digital file storage formatted data.

6. The system according to claim 1, further comprising:
means for recognizing gender of a participant in said interaction;
means for recognizing words in said interaction;
means for recognizing a number of speakers in said interaction;
means for recognizing a number of speakers in said interaction;
means for recognizing a language of said interaction;
means for recognizing an age of a participant in said interaction;
means for identifying a child participant of said interaction;
means for recognizing a quality of said interaction;
means for recognizing an audio quality of said interaction;
means for recognizing a video quality of said interaction;
means for evaluating said interaction;
means for selecting a particular interaction from a plurality of interactions for review by a reviewer;
means for scoring said interaction;
means for tracking attributes associated with said interaction, wherein said attributes comprise at least one of:
identity of participants in said interaction,
time of day of said interaction,
temporal attributes of said interaction,
duration of said interaction;
language of said interaction,
dialect of said interaction,
age of a participant of said interaction,
gender of a participant of said interaction,
number of speakers of said interaction,
words of said interaction,
quality of said interaction,
fidelity of said interaction,
topic of said interaction,
subject of said interaction, and/or
other attributes of said interaction;
means for capturing a screen associated with said interaction;
means for performing voice recognition on said interaction;
means for optical character recognition of said interaction;
means for pattern recognition of said interaction;
means for word spotting on said interaction;
means for identifying people from said interaction;
means for detecting stress from said interaction;
means for detecting emotion from said interaction;
means for detecting motion of a participant of said interaction;
means for synchronizing detected motion with said interaction;
means for identifying location of a participant of said interaction comprising at least one of identifying a position in three dimensional space of a participant, identifying a spatial position of the parties of said interaction, and/or identifying a height of a participant;
means for identifying geographic location of said interaction; and/or
means for geolocating said interaction.

7. The system according to claim 1, further comprising:
means for identifying participants in said interaction;
means for evaluating said interaction;
means for selecting a particular interaction from a plurality of interactions for review by a reviewer;
means for scoring said interaction;
means for tracking attributes associated with said interaction, wherein said attributes comprise at least one of:
identity of participants in said interaction,
time of day of said interaction,
temporal attributes of said interaction,
duration of said interaction;
language of said interaction,
dialect of a participant of said interaction,
age of a participant of said interaction,
gender of a participant of said interaction,
number of speakers of said interaction,
words of said interaction,
quality of said interaction,
fidelity of said interaction,
topic of said interaction,
subject of said interaction, and/or
other attributes of said interaction;
means for filtering said interaction;
means for improving quality of said interaction comprising at least one of: means for improving audio quality, and/or means for improving video quality;
means for increasing intelligibility of said interaction for at least one of: a human listener, and/or an automated speech recognition system;
means for removing noise comprising at least one of: means for removing background noise, means for removing air conditioner noise, means for removing heating noise, means for removing clothes rustling noise, and/or means for removing rumbling; and/or
means for performing digital speech signal processing comprising:
means for performing voice recognition; and/or
means for performing speech recognition comprising at least one of:
means for recognizing words,
means for recognizing phrases,
means for converting speech to text,
means for recognizing colloquialisms,
means for recognizing an accent,
means for recognizing intent of said words,
means for recognizing logic,
means for deciphering intent of said words, and/or
means for deducing desire of said participant.

8. The system according to claim 2, wherein said capture device comprises a wireless transmitter and said collection device comprises a wireless receiver.

9. The system according to claim 8, wherein said capture device comprises an encryption device adapted to encrypt said interaction prior to transmission over said wireless transmitter.

10. The system according to claim 8, wherein said collection device comprises a wideband receiver.

11. The system according to claim 8, wherein said collection device further comprises means for demodulating and filtering transmissions into separate channels.

12. The system according to claim 1, wherein said capture device comprises an encryption device.

13. The system according to claim 1, wherein said capture device comprises a storage device.

14. The system according to claim 1, wherein said face-to-face interaction between two parties comprises at least one of:
a manager and subordinate interaction;
a salesperson and customer interaction;
a peer to peer interaction;
a recruiter to recruit interaction;
an employer and candidate interaction;
a trainer and trainee interaction;
a loan officer and loan applicant interaction;
a human to human interaction;
a commercial interaction;
a business-related interaction;
a non-personal interaction;
a non-casual interaction; and/or
a customer and employee interaction.

15. The system according to claim 2, wherein said collection device comprises a docking station.

16. The system according to claim 15, wherein said docking station comprises at least one of:
a wired coupling;
a wireless coupling;
a cable;
a port replicator;
an aggregator;
a cradle;
an upload device;
an interface;
a radio;
a transmitter;
a transceiver; and/or
a docking device.

17. The system according to claim 1, wherein said analysis system comprises at least one of:
means for recording said interaction;
means for storing said interaction;
means for indexing said interaction;
means for archiving said interaction;
means for training;
means for marketing data capture;
means for market analysis capture;
means for understanding customers obviating a need for a focus group;
means for scoring said interaction;
means for calibrating reviews across an organization;
means for normalizing across a decentralized organization;
means for identifying potential marketing opportunities;
means for identifying customer needs;
means for identifying training needs including at least one of quantity, and/or type of training;
means for measuring results of training;
means for acquiring competitive intelligence;
means for customer relationship management (CRM);
means for analyzing customer satisfaction;
means for capturing customer requirements;
means for tracking compliance;
means for compiling evidence of at least one of regulatory, policy, and/or legal compliance;
means for tracking compliance to a process;
means for tracking completion of a closed loop process;
means for tracking compliance to protocol;
means for tracking compliance to standard operating procedures;
means for recruiting;
means for monitoring employee compliance;
means for employee evaluation;
means for tracking compliance to best practices;
means for analyzing a point of sale (POS) transaction; and/or
means for tracking employee behavior.

18. The system according to claim 1, wherein said analysis system is used as a processing support system for at least one of:
a business;
a retail sales environment;
a government agency;
a customer service function;
a border patrol interaction;
an airport interaction;
a security interaction;
a transportation security interaction;
a border control interaction;
a border agent interaction;
an automotive interaction;
an auto service interaction;
a used auto purchase interaction;
a new auto purchase interaction;
a financial interaction;
a banking interaction;
an insurance interaction;
a hospitality interaction;
a health care interaction;
a recruiting interaction;
a military recruiting interaction;
an internal revenue service (IRS) interaction;
an IRS audit interaction; and/or
an agency interaction.

19. The system according to claim 1, wherein said analysis system comprises at least one of:
an application service provider;
a central server;
a third party server;
a government server;
a financial server;
a bank server;
a host; and/or
a standalone system.

20. The system according to claim 1, wherein said analysis system is owned by a first owner and said capture device and said collection device are owned by a second owner.

21. The system according to claim 1, wherein said analysis system comprises means for mapping said interaction to business process analytics.

22. The system according to claim 21, wherein said business process analytics comprises at least one of:
a) receiving a process definition for a process comprising:
1) receiving at least one process step of said process, and
2) receiving at least one metric relating to each of said at least one process steps,
b) receiving a metric definition comprising
1) receiving a rule comprising at least one of:
A) receiving an identification of terms recognized by a word spotting engine from a given interaction, wherein said terms are part of a predetermined term list, wherein said predetermined termlist comprises a plurality of terms,
B) upon said identification of at least one of existence and/or nonexistence of a given term, an event is triggered,
C) upon said identification of a number of terms of a termlist falling at least one of below, within and/or above a numeric range, an event is triggered, and/or
D) upon said identification of a number of terms of a termlist at least one of exceeding, reaching and/or falling below a numeric threshold, an event is triggered;
c) receiving a term list definition comprising a list of a plurality of terms and/or phonetics of said terms, associated with a term list;
d) receiving a classification definition comprising a rule regarding at least one of a numeric threshold level and/or numeric range of terms of a term list recognized by the word spotting engine about a given interaction, associated with a given classification;
e) triggering an event based on a rule;
f) automatically assessing an interaction based upon a metric; and/or
g) automatically scoring an interaction based upon a metric.

23. The system according to claim 21, wherein said business process analytics further comprise performing an automated scoring assessment of said interaction.

24. The system according to claim 1, further comprising scoring said interaction against a process.

25. The system according to claim 2, wherein at least one of said capture device, said collection device and/or said analysis system are parts of the same device.

26. The system according to claim 1, wherein said analysis system comprises means for interactive access comprising at least one of:
a web-based interface;
a graphical user interface for interacting with said interaction;
a standalone application;
a client/server application;
an application service provider application;
means for searching;
means for archiving;
means for reviewing business rules;
means for triggering communications;
means for generating an alert;
means for generating a notification;
means for capturing meta data;
means for capturing time of day;
means for capturing a point in time;
means for capturing a duration of said interaction;
means for filtering said interaction;
means for capturing particular parties of said interaction;
means for filtering out an interaction of interest from a plurality of said interactions;
means for querying a database of a plurality of said interactions;
means for searching for words said during said interaction;
means for reviewing said interaction;
means for reviewing said interaction in synchronization with a screen capture; and/or
means for sending at least one of alerts, notifications, communications, and/or email.

27. The system according to claim 1, wherein said analysis system comprises means for processing comprising at least one of:
means for capturing attributes of said interaction;
means for capturing audio attributes of said interaction;
means for capturing video attributes of said interaction;
means for capturing screen data attributes of said interaction;
means for capturing temporal attributes of said interaction;
means for capturing geospatial attributes of said interaction;
means for capturing geographic attributes of said interaction;
means for capturing location attributes of said interaction;
means for capturing business attributes of said interaction;
means for capturing other attributes of said interaction;
means for capturing metadata attributes of said interaction;
means for storing data about said interaction;
means for indexing said data about said interaction;
means for indexing based on at least one of location, person, event, product, time, action and/or other attribute;
means for encrypting;
means for decrypting;
means for compressing;
means for decompressing;
means for coding;
means for decoding;
means for archiving;
means for restoring;
means for complying with regulatory requirements;
means for complying with legal requirements;
means for complying with policy requirements;
means for complying with governmental requirements;
means for complying with privacy requirements;
means for identifying speakers;
means for processing said interaction;
means for improving quality of said interaction;
means for removing noise from said interaction;
means for dividing up conversations;
means for dividing up portions of conversations;
means for inserting key frames;
means for inserting meta data;
means for detecting emotion;
means for indexing;
means for tagging; and/or
means for talkover.

28. The system according to claim 1, wherein said analysis system is adapted for interactive access comprising at least one of:
web-based interface;
means for listening to a conversation;
means for replaying said interaction;
means for accessing said interaction;
means for scoring said interaction;
means for evaluating said interaction;
means for performing time and motion studies of said interaction;
means for studying how long to qualify a customer;
means for studying how long to describe at least one of a product and/or a feature;
means for studying whether at least one of a feature and/or a product is discussed;
means for studying the temporal length of a portion of said interaction;
means for studying the length of time to take a test drive;
means for studying efficiency;
means for studying effectiveness;
means for analyzing competitive information;
means for detecting mention of a competitor's product;
means for gathering market research data;
means for detecting unfair trade practices;
means for confirming compliance with rules;
means for confirming compliance with union rules;
means for gathering consumer research;
means for sampling;
means for asking questions;
means for quantifying market data;
means for collecting data;
means for gathering data;
means for indexing data;
means for selling data; and/or
means for enabling purchase of data.

29. A method of capturing and/or analyzing an interaction comprising at least one of:
a) analyzing a face-to-face interaction captured from a capture device comprising:
(1) receiving the face-to-face interaction from the capture device,
(2) analyzing the interaction, and
(3) providing interactive access to the interaction;
b) capturing a face-to-face interaction for analysis at an analysis system comprising:
(1) capturing on a capture device a face-to-face interaction between at least two parties, and
(2) transmitting said interaction to the analysis system; and/or
c) collecting and analyzing a face-to-face interaction comprising:
(1) capturing a face-to-face interaction, and
(2) analyzing said interaction.

30. The system according to claim 1, wherein said ambulatory capture device comprises, coupled to the system, at least one of:
an ambulatory, portable, mobile, self-contained, dockable, digital capture device;
a dockable device;
a radio frequency dockable device comprising at least one of a WLAN and/or a wireless ethernet communications system;
a wired docking device;
a microphone;
an ambulatory microphone;
a headset microphone;
a wireless microphone;
a lapel microphone;
a USB microphone;
a nametag microphone;
an ambulatory microphone;
a digital storage device;
a user interface adapted to provide a recording indicator;
an analog to digital (A/D) converter;
secure encryption links;
secure encryption while recording;
a digital file-based file system;
encryption;
compression;
a directory structure;
single button start/stop recording;
computing timing via realtime clock based on analysis of sampling rate;
means for synchronizing time when docked; and/or
means for transferring recorded data over a digital data network when docked.

31. The system according to claim 2, wherein said collection device comprises, coupled to the system, at least one of:
an interface adapted to be coupled to said capture device;
a universal serial bus interface (USB) interface;
a data network interface;
an ethernet interface;
means for coupling data from said capture device to said analysis system;
means for uploading said interactions;
means for uploading said interactions to an application service provider;
an inexpensive device; and/or
means for providing secure, encrypted transmission.

32. The system according to claim 1, wherein said analysis system comprises, coupled to the system, at least one of:
means for centralized analysis;
means for host based backend processing;
means for an application service provider (ASP) system;
means for voice activated analysis;
means for voice activated filtering;
means for detecting voice;
means for detecting silence;
means for cleaning up audio;
means for filtering audio;
means for removing unwanted noise;
means for wordspotting;
means for voice recognition;
means for speaker recognition;
means for speech recognition;
means for indexing;
means for automatic gain control;
means for providing web access to said interaction;
means for providing playback of said interaction;
means for providing playback of a snippet before and after an identified term;
means for screen capture;
means for capturing state of computer monitor synchronized with interaction;
means for enforcing a business process;
means for triggering alerts;
means for enabling assessments;
means for enabling scoring assessments;
means for receiving a classification definition;
means for receiving a term list definition;
means for receiving a term definition;
means for receiving a process definition;
means for receiving a process step definition;
means for receiving a metric definition;
means for receiving a role definition;
means for receiving a trigger definition;
means for receiving an event definition;
means for receiving a process definition comprising at least one of:
means for receiving a process,
means for receiving at least one process step of said process, and/or
means for receiving at least one metric associated with each of said process steps;
means for receiving a term list definition; and/or
means for identifying terms from a term list;
means for identifying identified terms from a term list recognized in an interaction using a wordspotting engine;
means for determining a number of identified terms appearing in a term list;
means for triggering events based on a rule relating to a number of identified terms appearing in a term list;
means for automatically scoring said interaction;
means for automatically assessing said interaction; and/or
means for classifying said interaction based on a plurality of predetermined classifications.
